(19) United States
(12) Patent Application Publication
(10) Pub. No.: US 2017/0022736 A1
(43) Pub. Date: Jan. 26, 2017

(54) Multi-function latch and latch bolt

(71) Applicant: Trung T. Nguyen, Plano, TX (US)

(72) Inventor: Trung T. Nguyen, Plano, TX (US)

(21) Appl. No.: 14/805,479

(22) Filed: Jul. 22, 2015

(51) Int. Cl. E05B 63/00; E05B 65/08; E05B 65/00; E05B 65/06; E05B 55/00; E05B 57/00

(52) U.S. Cl. CPC E05B 63/0004; E05B 55/00; E05B 57/00; E05B 63/0034; E05B 65/0007; E05B 65/06; E05B 65/087

(57) ABSTRACT

A multi-function latch and latch bolt are configured as a pair of mechanical fastener to be installed on a gate for the purpose of holding the gate in closed position, and that a person standing on the inside of the fence can disengage the latch hook bracket from the latch bolt, or disengage the latch bolt from the latch hook bracket in any of which method to unlatch and open the gate from inside the fence even when the outside of the latch is locked. On the other hand, when the latch is not locked on the inside but locked on the outside with an incorporated lock, keyed or combination padlock; then a person standing on the outside of the gate may open the gate if he/she has an appropriate key or knows the combination codes in order to unlock, unlatch and open the gate from outside the fence.

### FIELD OF THE INVENTION

The present invention relates to new and improved functionality of latches and latch bolts for use on fence gates or doors. More particularly, but not exclusively, the present invention relates to a gate latch and latch bolt for installing on a wood gate and/or fence frame, wood or metal door where a person can unlatch from inside the fence even when the outside of the latch is locked with an incorporated lock, a third party keyed or combination padlock or the like to prevent a person from being locked in; On the other hand, a person standing on the outside of the gate may unlatch the gate or door when the latch is not locked on either side; However, when the latch is locked only on the outside with an incorporated lock, a keyed or combination padlock, then a person is required to have an appropriate key or know the combination codes in order to unlock, unlatch and then open the gate from outside the fence; the gate latch can be locked on the inside of the fence with a padlock or simply tie a wire at the lock holes to prevent the latch-hook bracket from being lifted by the handle bar on the outside of the fence.

### BACKGROUND OF THE INVENTION

Fences are constructed as a means of providing security, safety and privacy as well as restricting or preventing trespassing, burglary or unauthorized persons from entering into the enclosed area, such as a backyard, garden, barn or any enclosed outdoor fenced structure; however, an enclosed fence usually have at least one gate for entrance or exit. Swing gates are generally used on residential fences, and sliding gates are generally used on residential and commercial fences where a person may enter or exit the enclosed areas. Deterring would-be burglar or unauthorized person is one of the most effective forms of crime prevention. Having a bold latching system mounted and locked on a gate will hopefully prevent burglars or unauthorized person from entering. A mechanical fastener such as a latch and latch bolt are utilized to hold the gate in closed position and yet to allow the gate to swing or slide open when being unlatched. Normally, when a homeowner uses a padlock for the gate latch on the inside to prevent someone on the outside of the fence from entering into the enclosed area, but if the homeowner wants to give access to certain person such as a relative or a trusted house cleaner, a padlock has to be installed on the outside of the gate latch instead of on the inside; therefore, the person on the outside must have an appropriate key or know the combination codes for the padlock; unfortunately, as when the latch is locked on the outside, the homeowner on the inside cannot open the gate and therefore being locked in or has to find an alternative way to get to the outside of the fence to unlock the padlock in order to unlatch and open the gate from outside.

Currently, there is no known prior latch and latch bolt offering the solution to the problem. It is, therefore, an object of the invention to provide a new solution to a long-time problem that allows certain person to gain access from outside the fence, and a person on the inside of the fence can open the gate even when the gate latch is locked on the outside.

### SUMMARY OF THE INVENTION

While a gate latch is locked on the outside of the fence, a person on the inside of the fence still can disengage the gate latch to open the gate by lifting the latch-hook bracket away from the latch bolt; or swinging the latch bolt pivotably or sliding the latch bolt horizontally away from the latch-hook bracket. A padlock can be used to lock the gate latch on the inside of the gate so that a person on the outside of the gate cannot open the gate; thereby, preventing any unauthorized person from entering through the gate. On the other hand, when a padlock is installed on the outside of the gate latch, only authorized person with an appropriate key or combination codes may unlock and unlatch the gate latch. An integral lock may be incorporated onto the gate latch; for example, a cam lock may be incorporated as a part of the gate latch for use with a key or combination code.

The present invention is directed to new and useful alternatives to known products and methods to help solving problem that the person standing on the inside of the gate cannot open the gate because the gate latch is locked on the outside.

### BRIEF DESCRIPTION OF THE DRAWINGS

The subject matter regarded as the invention is specifically mentioned and claimed in the concluding portion of the specification. The invention, however, both as configuration and method of operation, together with features and functionalities thereof will be or become apparent to those skilled in the art upon reference to the following detailed description when read with the accompanying drawings. It is intended that any additional configurations, modifications, methods of operation, features or advantages ascertained by those skilled in the art be included within this description, be within the scope of the present invention and be protected by the accompanying claims.

In regard to the drawings, FIG. 1 is a dimetric view of the first major configuration of a gate latch of the present invention; said first major configuration will continue to FIG. 19 on page 18/50;

FIG. 2 is a dimetric view of a basic latch bolt of the present invention as shown on page 1/50;

FIG. 3 is a dimetric view of the gate latch showing main parts with a latch-hook bracket in a latched position, as shown on page 2/50;

FIG. 4 is a dimetric view of the gate latch with a latch-hook bracket in an unlatched position, as shown on page 3/50;

FIGS. 5, 6 & 7 are dimetric views of the gate latch as viewed from the back side of the gate latch where the base bracket would be attached to the gate structure or the fence frame structure, as seen on page 4/50, 5/50 and 6/50;

FIG. 8 is an exposed side view of the gate latch showing the latch-hook bracket in a latched position, as seen on page 7/50;

FIG. 9 is an exposed side view of the gate latch showing the latch-hook bracket in an unlatched position, as seen on page 8/50;

FIG. 10 is an exposed side view of the gate latch showing the gate latch is being actuated from outside the gate to lift the latch-hook bracket upwardly along with the inside portion of the handle bar, as seen on page 9/50;

FIG. 11 is a dimetric view of the gate latch showing the exposed side of the gate latch having a guide hook to guide the handle bar, as seen on page 10/50;

FIG. 12 is a dimetric view of the gate latch showing the handle bar pivotably attached on the exposed side of the gate latch, as seen on page 11/50;

FIG. 13 is a dimetric view of the gate latch showing the back side of the gate latch with the handle bar positioned on the exposed side, as seen on page 12/50;

FIG. 14 is a dimetric view of the gate latch showing the back side of the gate latch with the latch-hook bracket having a spring rod or an extended portion of the bolt with a spring loaded, as seen on page 13/50;

FIG. 15 is a dimetric view of the gate latch showing the back side of the gate latch with a single-hook structure pivotably attached to the base bracket by a rivet or bolt/nut; said single-hook bracket having no spring rod, as seen on page 14/50;

FIG. 16 shows a spring rod in place of the rivet or bolt/nut, as seen on page 15/50;

FIG. 17 is an exposed side view of the gate latch showing the handle bar positioned on the exposed side, as seen on page 16/50;

FIG. 18 is an exposed side view of the gate latch showing the latch-hook bracket in an unlatched position while the handle bar is unactuated, as seen on page 17/50;

FIG. 19 is and exposed side view of the gate latch showing the handle bar is in an actuated position and the latch-hook bracket is raised to an unlatched position, as seen on page 18/50;

FIG. 20 is a dimetric view of the second major configuration of the gate latch showing main parts, starts on page 19/50; said second major configuration will continue to FIG. 27 on page 26/50;

FIG. 21 is an exposed side view of the gate latch showing the latch-hook bracket is in a latched position, as seen on page 20/50;

FIG. 22 is an exposed side view of the gate latch showing the latch-hook bracket is in an unlatched position, as seen on page 21/50;

FIG. 23 is an exposed side view of the gate latch showing the handle bar is in an actuated position with the latch-hook bracket being raised along with the inside portion of the handle bar, as seen on page 22/50;

FIG. 24 is a dimetric view of the gate latch showing the handle bar positioned on the exposed side of the base bracket, as seen on page 23/50;

FIG. 25 is an exposed side view of the gate latch showing the handle bar positioned on the exposed side of the base bracket and the latch-hook bracket is in a latched position, as seen on page 24/50;

FIG. 26 is an exposed side view of the gate latch showing the latch-hook bracket in an unlatched position, as seen on page 25/50;

FIG. 27 is an exposed side view of the gate latch showing the handle bar in actuated position and the latch-hook bracket is raised up from the latched position, as seen on page 26/50;

FIG. 28 is a dimetric view of the third major configuration of the gate latch showing main parts, starts on page 27/50; said third major configuration will continue to FIG. 42 on page 41/50;

FIG. 29 is a dimetric view showing the handle bar positioned on the inside of the base bracket, as seen on page 28/50;

FIG. 30 is an exposed side view of the gate latch showing the handle bar and the latch-hook bracket in a latched position, as seen on page 29/50;

FIG. 31 is an exposed side view of the gate latch showing the handle bar and latch-hook bracket in an unlatched position, as seen on page 30/50;

FIG. 32 is a dimetric view showing the exposed side view, as seen on page 31/50;

FIG. 33 is a dimetric view showing the back side of the gate latch with the latch-hook bracket having no spring rod, as seen on page 32/50;

FIG. 34 is a dimetric view showing the back side of the gate latch with the latch-hook bracket having a spring rod and loaded spring, as seen on page 33/50;

FIG. 35 is a dimetric view showing the back side of the gate latch with the latch-hook bracket being a single-hook structure, as seen on page 34/50;

FIG. 36 is an exposed side view of the gate latch showing the handle bar and latch-hook bracket in a latched position, as seen on page 35/50;

FIG. 37 is an exposed side view of the gate latch showing the handle bar and latch-hook bracket in an unlatched position, as seen on page 36/50;

FIG. 38 is and exposed side view of the gate latch showing the latch-hook bracket being raised up to an unlatched position without actuating the handle on the outside of the gate, as seen on page 37/50;

FIG. 39 is a dimetric view showing main parts and a lift-stop plate, as seen on page 38/50;

FIG. 40 is an exposed side view of the gate latch showing the latch-hook bracket with a lift-stop plate in a latched position, as seen on page 39/50;

FIG. 41 is and exposed side view of the gate latch showing the latch-hook bracket with a lift-stop plate being raised to an unlatched position, as seen on page 40/50;

FIG. 42 is a dimetric view of the gate latch having no lift-stop plate so that the locking bolt, as seen on FIG. 55, can slide horizontally to the latch-hook bracket, and the locking bolt can be swung downwardly so the latch-hook bracket can be unlatched, as seen on page 41/50;

FIG. 43 is a dimetric view showing the back side of the gate latch including an incorporated camlock with a key, as seen on page 42/50;

FIG. 44 is a dimetric view showing the back side of the gate latch including an incorporated camlock with combination code rings, as seen on page 43/50;

FIG. 45 is a dimetric view of the handle bar with a bolt fastened to guide the handle bar, as seen on page 44/50;

FIG. 46 is a dimetric view of the handle bar with a hook incorporated to guide the handle bar, as seen on page 44/50;

FIG. 47 is a dimetric view of the handle bar showing a pull rod at the inside end portion of the handle bar, as seen on page 45/50;

FIG. 48 is a dimetric view of the handle bar having a hollow channel so the user can pull the handle bar to actuate the gate latch, as seen on page 45/50;

FIG. 49 is a dimetric view of the handle bar showing a handle rod installed on the outside end, as seen on page 46/50;

FIG. 50 is a dimetric view of the handle bar showing a handle portion on the outside turning 90 degrees, as seen on page 46/50;

FIG. 51 is a dimetric view of the handle bar showing it in a flat figure, as seen on page 47/50;

FIG. 52 is a dimetric view of the handle bar showing a pulling channel to pull the latch-hook bracket, as seen on page 47/50;

FIG. 53 showing the lift-stop plate, as seen on page 47/50;

FIG. 54 is a dimetric view of the latch bolt mechanism showing the locking bolt in an extended position, as seen on page 48/50;

FIG. 55 is a dimetric view of the latch bolt mechanism showing the locking bolt in a retracted position, as seen on page 48/50;

FIG. 56 is a dimetric view of the latch bolt mechanism showing the extended panels having screw holes for fastening to the fence structure, also a locking bolt is bent to become a handle, as seen on page 49/50;

FIG. 57 is a dimetric view of the latch bolt mechanism showing the back wall panel with screw holes for fastening to the fence structure, also a locking bolt is bent to become a handle, as seen on page 49/50;

FIG. 58 is a dimetric view of the latch bolt mechanism showing the locking bolt in an extended position, as seen on page 50/50;

FIG. 59 is a dimetric view of the latch bolt mechanism showing the locking bolt in a retracted position, as seen on page 50/50;

FIG. 60 is a dimetric view showing the locking bolt bent in between the extended panels to become a handle, as seen on page 50/50.

### DETAILED DESCRIPTION OF THE DRAWINGS

The followings are described as the preferred embodiments of the multi-function latch and latch bolt in accordance with the present invention. In describing the embodiments illustrated in the drawings, certain terminology will be used for consistency and clarity. Where similar elements have been depicted in multiple embodiments, identical reference numerals have been used on certain parts for simplicity and ease of understanding. It will become evident to those skilled in the art that several objectives and advantages of this invention follow from the novel method by which a person inside the gate can unlatch the latch-hook bracket from the locking bolt or unlatch the locking bolt from the latch-hook bracket in order to open the gate even when the gate latch is locked on the outside of the fence with an incorporated lock or a padlock.

The gate latch includes two components: a latch mechanism and a latch bolt mechanism. The latch mechanism comprises a base bracket, a handle bar and a latch-hook bracket; and the latch bolt mechanism comprises a base housing and a locking bolt. The latch-hook bracket comes in at least three different embodiments and each embodiment may be a double-hook structure or a single-hook structure; and the locking bolt comes in at least two different methods of actuation and/or configured for specific latch mechanism. The base bracket and the handle bar are modified to adapt a specific latch-hook bracket configuration. The handle bar is pivotably attached to the base bracket at a pivot point where the base bracket and the handle bar are configured to work according to one of the preferred embodiments. The latch-hook bracket is pivotably attached to the inside portion of the handle bar where the user can lift the latch-hook bracket upwardly or push the latch-hook bracket downwardly to raise the hook tongue up in order to disengage the latch-hook bracket from the locking bolt, or disengage the locking bolt from the latch-hook bracket by sliding the locking bolt horizontally away from the latch-hook bracket or push the locking bolt downwardly away from the latch-hook bracket. The base bracket may comprise a lift-stop plate to prevent the locking bolt from being swung downwardly. The lift-stop plate can be configured to swing horizontally so that the locking bolt can be swung vertically in a downward direction away from the latch-hook bracket. The gate can be unlatched from inside the gate even when the outside of the gate latch is locked.

The latch mechanism may be manufactured in configurations that the user may disassemble, rearrange and assemble in order to install the latch mechanism on different situations, such as left hand or right hand placement, inswing or outswing operation.

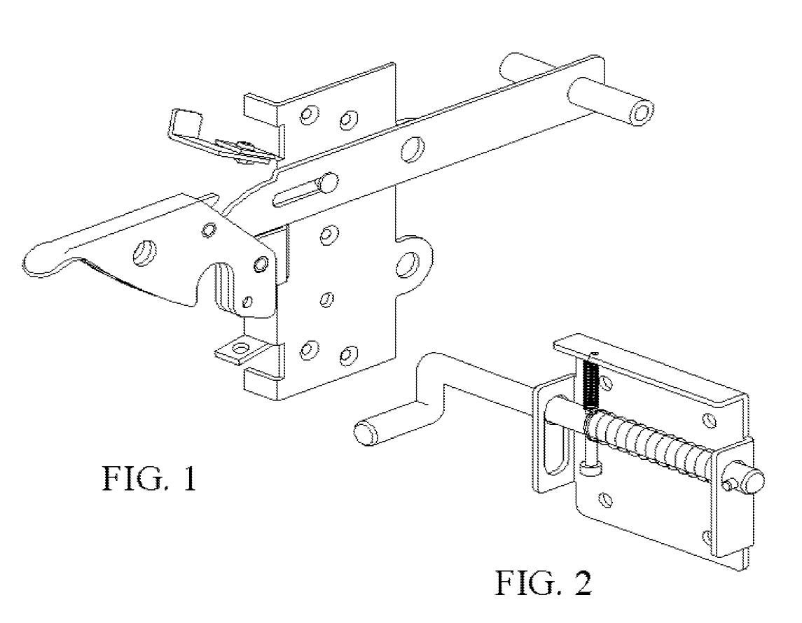

Referring now to the figures, FIGS. 1 & 2 depicts a pair of the first preferred embodiments of the multi-function latch and latch bolt. The latch (FIG. 1) can be installed onto a gate and the latch bolt (FIG. 2) can be installed onto an adjacent fence structure. The latch (FIG. 1) can also be installed on a fence frame structure and the latch bolt (FIG. 2) can be installed on a gate. The latch (FIG. 1) and latch bolt (FIG. 2) can be manufactured for left-hand/right-hand installation or for inswing/outswing operation.

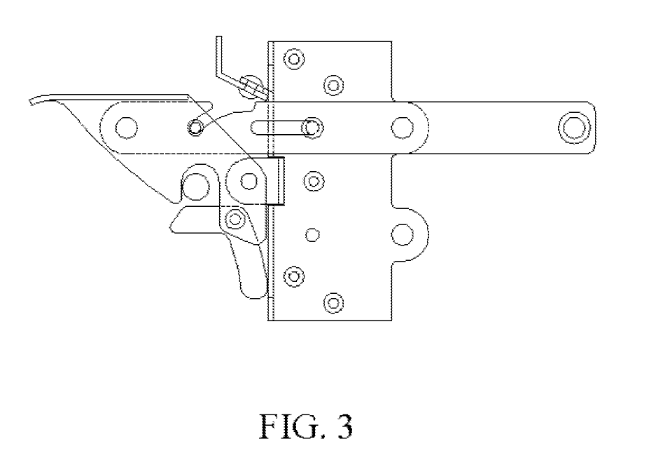

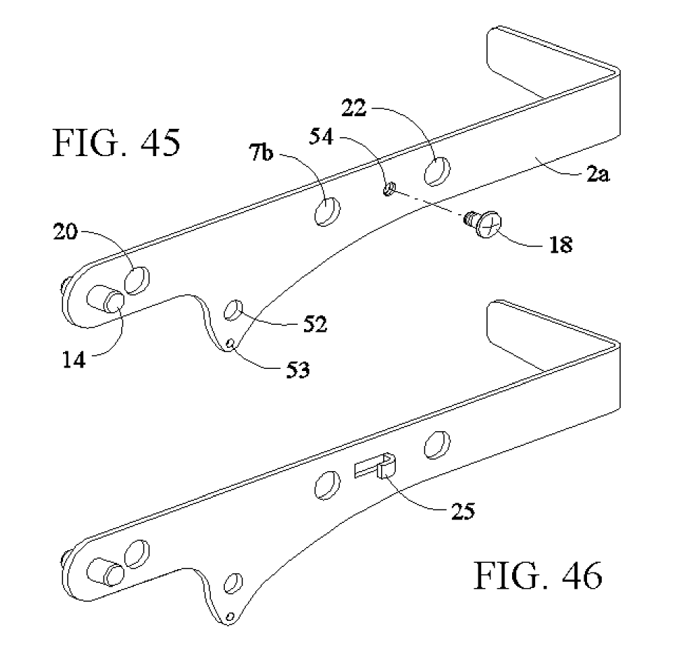

From a conceptual sketch to a finished product, many changes would come in along the way. FIG. 3 shows a latch in a basic configuration. Refer to FIG. 45 for reference numbers not shown on FIG. 3. The latch-hook bracket 3a on FIG. 3 is a double-hook structure having a spoon-like plate 19 for the user to lift the latch-hook bracket 3a up from latched position. Rivet or bolt 5a is used to fasten latch-hook bracket 3a onto the inside portion of the handle bar 2a; said rivet or bolt 5a is fasten through holes 5 with hole 52 in between (as seen on FIG. 45). Holes 6 on the latch-hook bracket 3a with hole 20 (as seen on FIG. 45) on the handle bar 2a (FIG. 45) are for a padlock when needed. The base bracket 1a has a projected wall portion 4 for the handle bar 2a pivotably attached on the inside of the projected wall portion 4 where a rivet or bolt 7c is fastened through hole 7a and to hole 7b (as seen on FIG. 45) which can be a threaded hole to hold bolt 7c in place in order to keep handle bar 2a pivotably attached to base bracket 1a. Bolt 18 is fastened through channel hole 17 and into hole 54 (as seen on FIG. 45) to keep handle bar 2a pivotably attached to the base bracket 1a. Also, hole 8 on the base bracket 1a and hole 22 on the handle bar 2a (as seen on FIG. 45) are used for a padlock for locking the latch (FIG. 1) from outside the fence. Hole 9 is used as a spare to hold a padlock when not in use. A pull rod 14 is installed onto the end portion of the handle bar 2a to pull the latch-hook bracket 3a upward and out of the latched position. Hole 12a and hole 53 (as seen on FIG. 45) are used for spring 12 to hold the handle bar 2a in rest position. A lift-stop plate 13 is extended from the base bracket 1a to keep the gate from being lifted which in turn lifting the latch-hook bracket 3a out of the latched position; said lift-stop plate 13 has a hole 10 to hold a padlock when not in use. A secondary locking bolt 16 and a hinge-like bracket 15 is incorporated onto the inside portion of the base bracket 1a where it can be manually set to keep the handle bar 2a from being actuated by a person on the outside of the fence. Holes 11 are used for screws or bolts (not shown) to fasten the latch (FIG. 1) to a gate or fence structure.

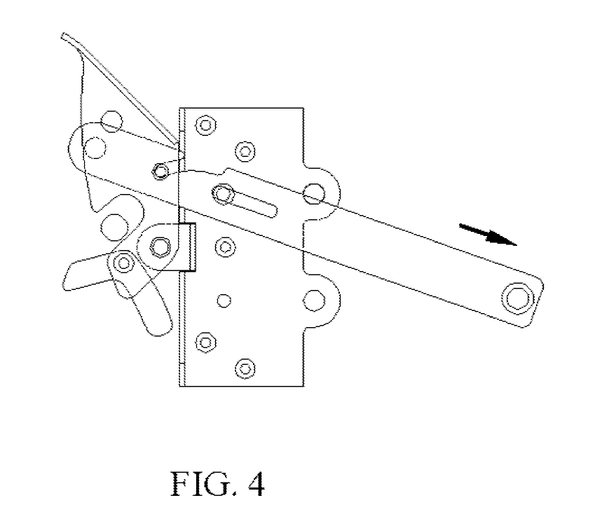

As shown on FIG. 4, the latch-hook bracket 3a in an unlatched position which means the holes 6 and catch tongue 21 are not in rest position, while the handle bar 2a and hole 20 are in rest position. This illustrates the situation when the handle bar 2a is not actuated on the outside of the gate, but someone inside the gate has lifted the latch-hook bracket 3a upwardly to unlatch the gate, most likely by lifting the spoon-like plate 19 upwardly to raise the latch-hook bracket 3a out of latched position.

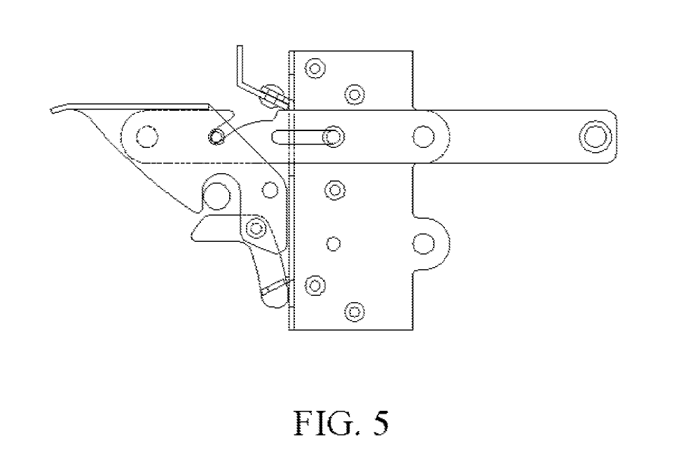

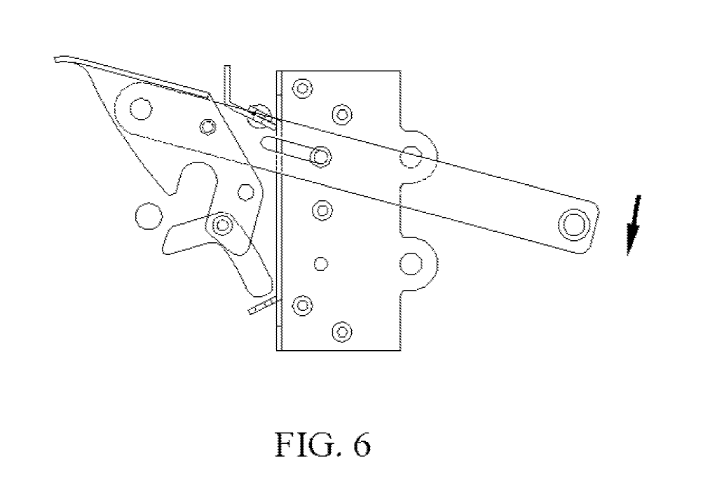

FIG. 5 shows the back side of the latch when the latch is in latched position and the secondary locking bolt 16 is in latched position which prevents the handle bar 2a from being lifted. Hole 22 is aligned with hole 8 where a padlock (not shown) can be hooked into. A spring rod 23 or an extended portion of the fasten bolt 23 which has a spring loaded to keep the latch-hook bracket 3a in rest position. FIG. 6 shows a rivet 5 or bolt 5 fastened in place. FIG. 7 shows the latch-hook bracket 3g as a single-hook structure.

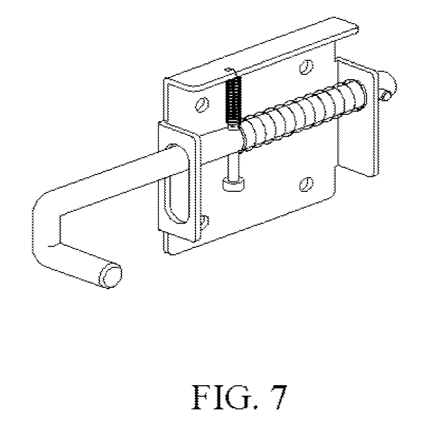

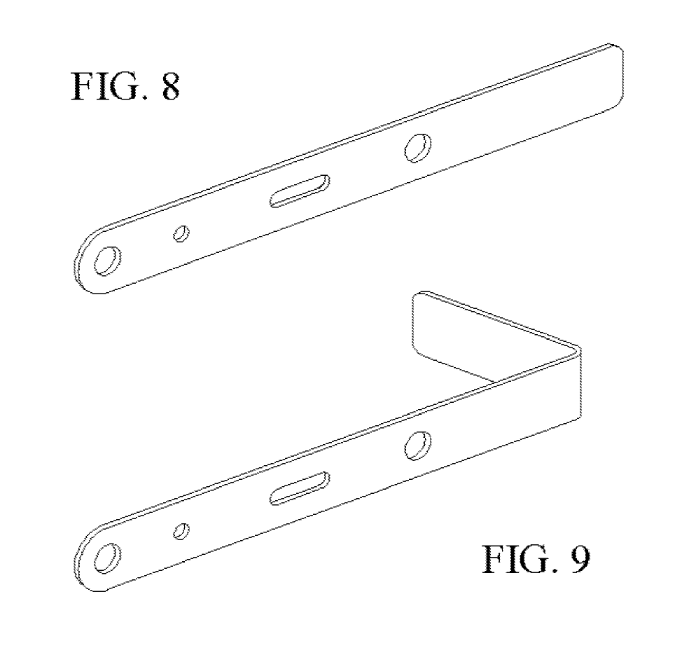

FIG. 8 shows the handle bar 2a and the latch-hook bracket 3a in a latched position.

FIG. 9 shows the handle bar 2a is in rest position, and the latch-hook bracket 3a is in an unlatched position which is raised over the locking bolt 24.

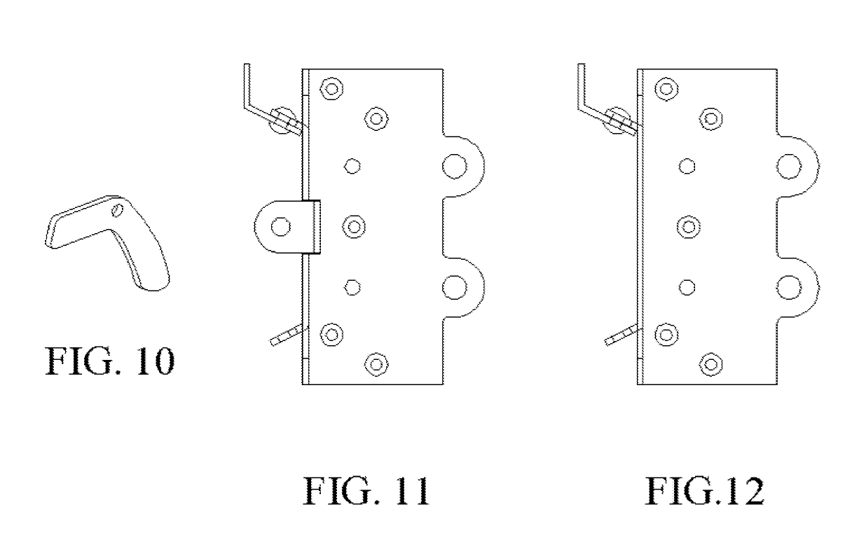

FIG. 10 shows the handle bar 2a is being actuated in the arrow direction by a person on the outside of the gate, which in turn lifted the latch-hook bracket 3a upwardly; therefore, the catching tongue 21 is raised over the locking bolt 24. A person on the outside of the gate can now open the gate.

FIG. 11 shows the guide hook 25 (also as seen on FIG. 46) in place of the guide bolt 18 (as seen on FIG. 3 or FIG. 45).

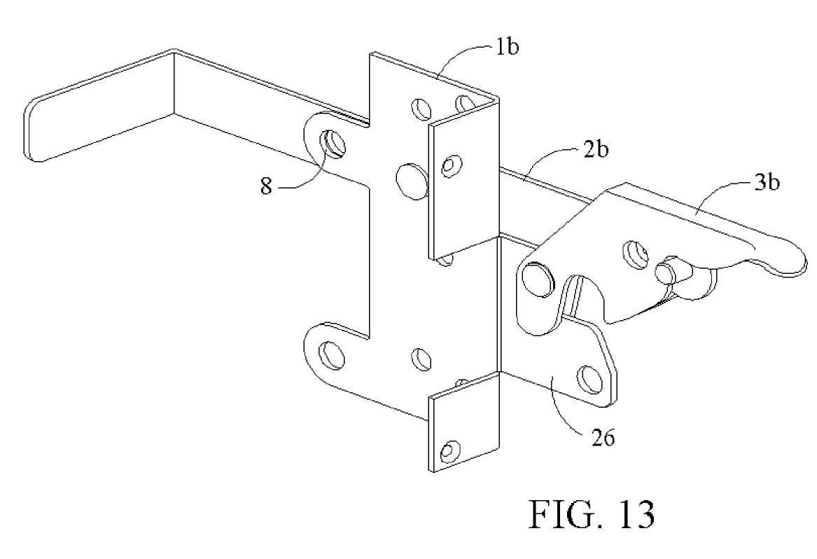

FIG. 12 shows the handle bar 2b pivotably attached on the exposed side of the base bracket 1b by bolt 7. Through hole 22 is aligned with an adjacent hole 8 (as seen on FIG. 13) for a padlock (not shown) to hook into and through hole 9 is a spare hole to hold a padlock (not shown) when not in use. Holes 11 are for screws or bolts (not shown) fastened to hold the latch onto a gate or fence structure. Latch-hook bracket 3b is being raised and holes 6 are out of alignment with hole 20. A pull rod 14 is attached near the inside end portion of the handle bar 2b which can be a rivet or bolt 14 fastened in place. A lift-stop plate 26 is utilized to prevent the gate from being lifted out of latched position. Even though FIG. 12 does not show a secondary locking bolt 16 and a hinge-like bracket 15 as seen on FIG. 3, a secondary locking bolt 16 and a hinge-like bracket 15, as seen on FIG. 3, can be incorporated to enhance this model. The lift-stop plate 26 also has a hole 10 for a padlock (not shown) to hook into.

FIG. 13 shows the back side view of a model shown on FIG. 12. The base bracket 1b having a handle bar 2b pivotably attached on the outside surface. Hole 8 is aligned with hole 22 (as seen on FIG. 12) and latch-hook bracket 3b is in a latched position. The lift-stop plate 26 is shown in relation to the latch-hook bracket 3b as viewed from a different angle.

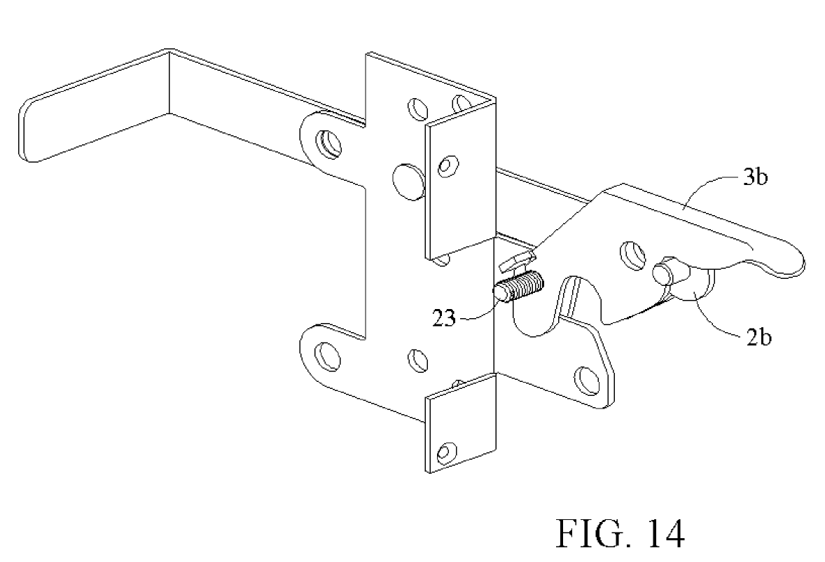

FIG. 14 shows the spring rod 23 incorporated as part of the latch-hook bracket 3b; said loaded spring on the spring rod 23 is a torsion spring for the purpose of pressing the latch-hook bracket 3b onto the inside end portion of the handle bar 2b.

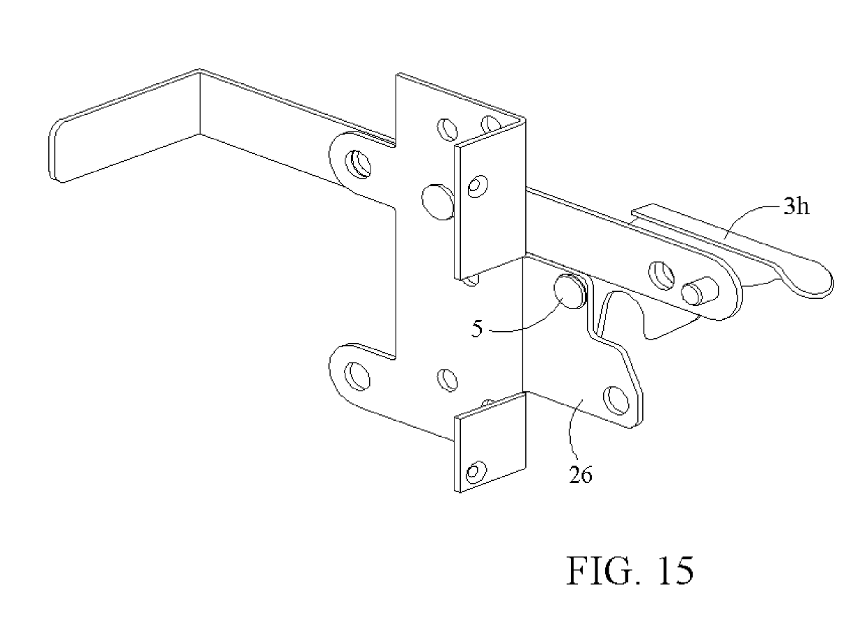

FIG. 15 shows the latch-hook bracket 3h being a single-hook structure pivotably attached to the lift-stop plate 26. A rivet 5 is used to pivotably attached the latch-hook bracket 3h to the lift-stop plate 26; said rivet 5 can be replaced with a bolt/nut 5a (as seen on FIG. 3).

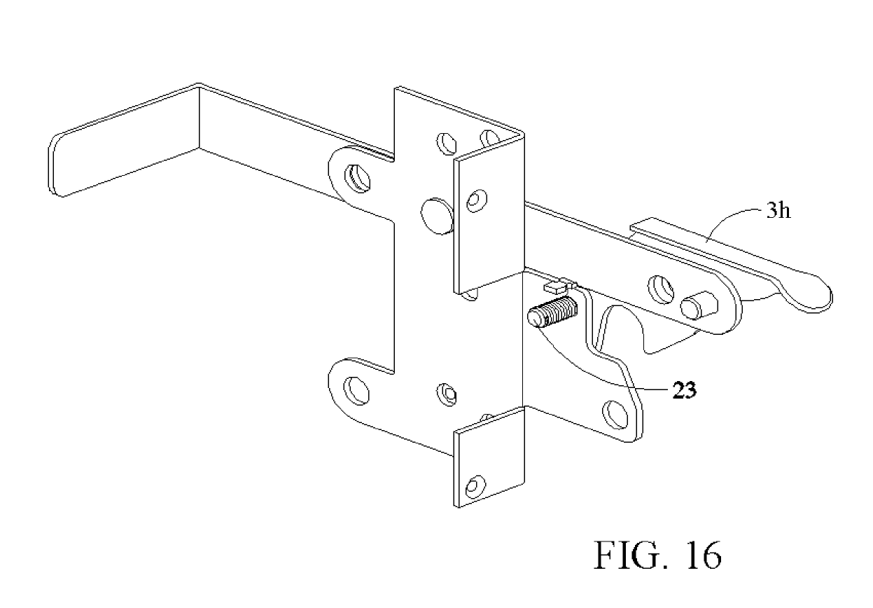

FIG. 16 also shows the latch-hook bracket 3h being a single-hook structure. The spring rod 23 can be utilized instead of a rivet 5 or bolt/nut 5a (as seen on FIG. 3).

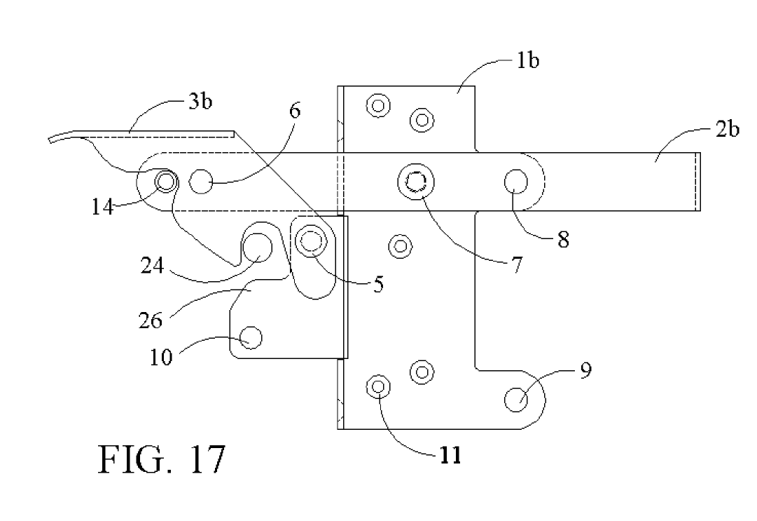

FIG. 17 shows the relations of the parts being assembled and locations of the holes aligning at certain points. Pull rod 14 is positioned near the inside end portion of the handle bar 2b so that when the handle bar 2b is being actuated from outside the fence, the pull rod 14 would lift the latch-hook bracket 3b upwardly out of the latched position. Bolt 7 is the pivot point where the handle bar 2b is pivotably attached to the base bracket 1b, hole 8 on the base bracket 1b is aligned with hole 22 (as seen on FIG. 12) on the handle bar 2b, hole 6 on the latch-hook bracket 3b is aligned with hole 20 (as seen on FIG. 12) on the handle bar 2b, and bolt 5 is used to fasten latch-hook bracket 3b to the lift-stop plate 26. Hole 10 is for a padlock (not shown) to hook into when not in use on the inside, and hole 9 is for a padlock (not shown) to hook into when not in use on the outside. Base bracket 1b having holes 11 for installation to the gate or fence frame structure. Locking bolt 24 is shown in relation to the latch-hook bracket 3b in a latched position.

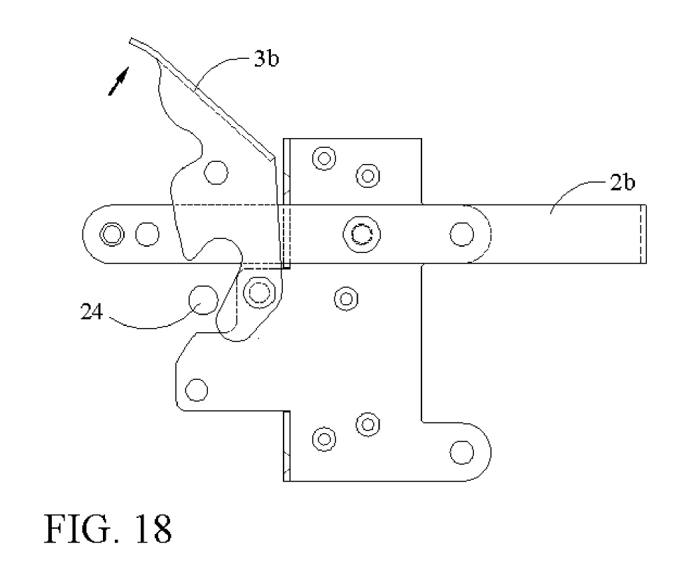

FIG. 18 shows the latch-hook bracket 3b in an unlatched position, which is not being hooked onto the locking bolt 24, while the handle bar 2b is in an unactuated position.

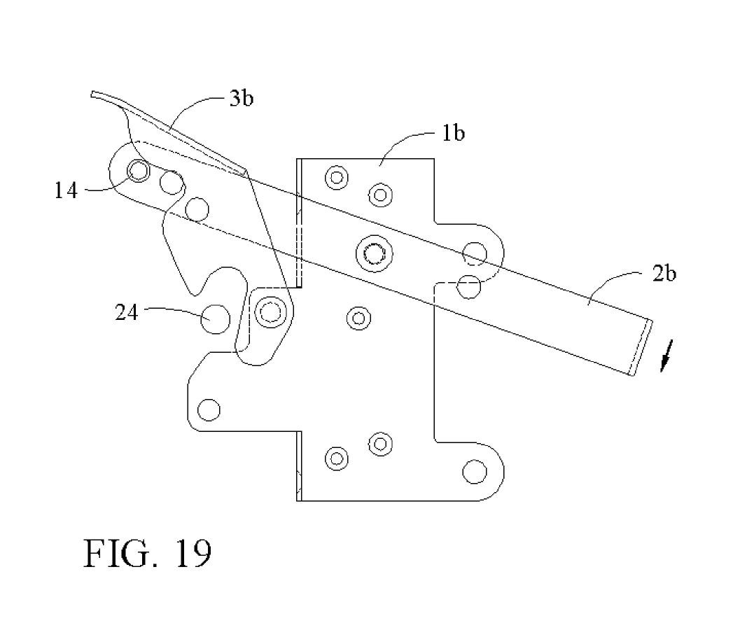

FIG. 19 shows the handle bar 2b in relation to the base bracket 1b where both handle bar 2b and latch-hook bracket 3b are in an unlatched position when the handle bar 2b is being pulled down in the arrow direction. The pull rod 14 moved out of the rest pocket on the latch-hook bracket 3b, and also the locking bolt 24 is out of the hook tongue under the latch-hook bracket 3b.

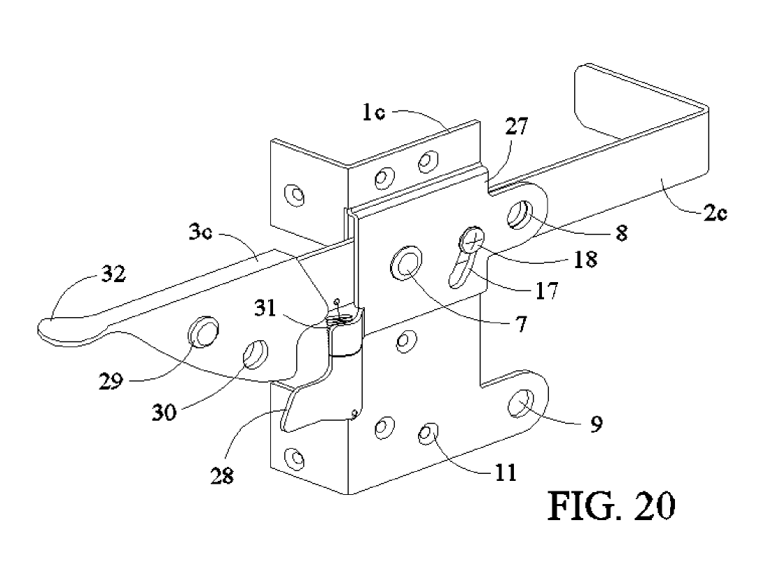

FIG. 20 depicts the second preferred embodiment of the multi-function latch and latch bolt. The latch-hook bracket 3c is pivotably attached to the inside end portion of the handle bar 2c at bolt 29 and the holes 30 on the latch-hook bracket 3c is for a padlock (not shown) to hook into when the latch should be locked on the inside of the fence to prevent a person inside the fence from unlatching the gate latch with the condition that the latch must be locked on the outside. In this case, the locking bolt (not shown) being attached on the adjacent fence structure must be a fixed bolt. The base bracket 1c has a projected portion 27 of the wall where the handle bar 2c is pivotably attached to the inside surface of the base bracket 1c by a rivet or bolt 7. Hole 8 and adjacent hole on handle bar 2c are for a padlock (not shown) to hook into when locked. Bolt 18 is fastened through the channel hole 17 and into the aligned hole on the handle bar 2c as an optional feature. Holes 11 are for screws or bolts (not shown) to fasten the latch to the gate or fence frame structure. A spoon-like plate 32 may be incorporated onto the latch-hook bracket 3c so that the user can lift the latch-hook bracket upwardly out of latched position. A lift-stop plate 28 is curved and having a spring 31 hooked to the bottom hole on the lift-stop plate 28 and also hook to the handle bar 2c. Hole 9 is a spare hole for a padlock (not shown) to hook into when not in use. Handle bar 2c can be a flat plate without a bent portion on the outside. As seen on FIG. 3, a secondary locking bolt 16 and hinge-like bracket 15 can be incorporated onto the inside portion of the base bracket 1c where it can be manually set to keep the handle bar 2c from being actuated by a person on the outside of the fence.

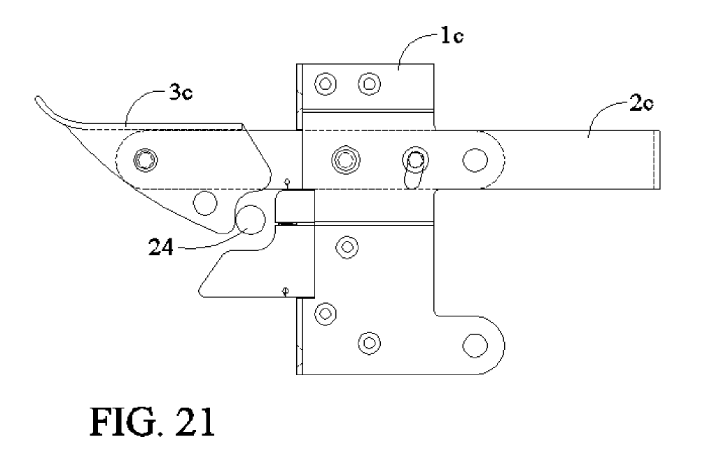

FIG. 21 shows the relation of the parts assembled. Latch-hook bracket 3c is in rest position and the locking bolt 24 is in place of being latched. The handle bar 2c is also in rest position in relation to the base bracket 1c.

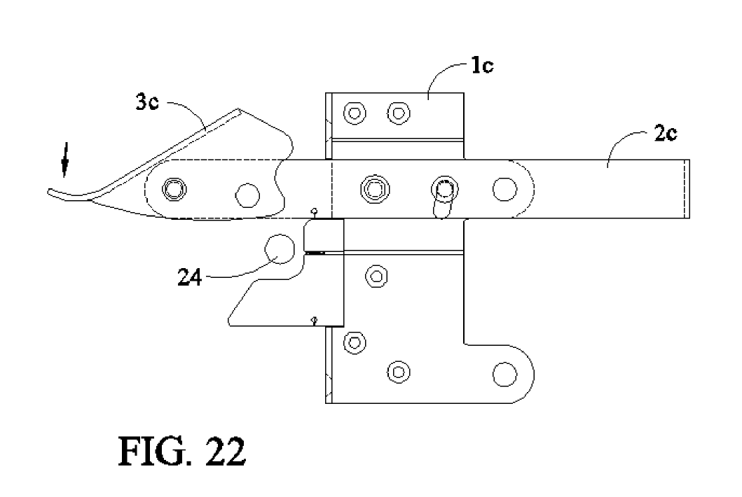

FIG. 22 shows the handle bar 2c is in rest position in relation to the base bracket 1c; however, the latch-hook bracket 3c is being pushed downwardly in the arrow direction which causes the latch-hook bracket 3c to raise upwardly away from the locking bolt 24. This demonstrates that while the outside of the latch is locked, a person standing on the inside of the gate can unlatch the latch-hook bracket 3c in order to open the gate even when the outside of the latch is locked.

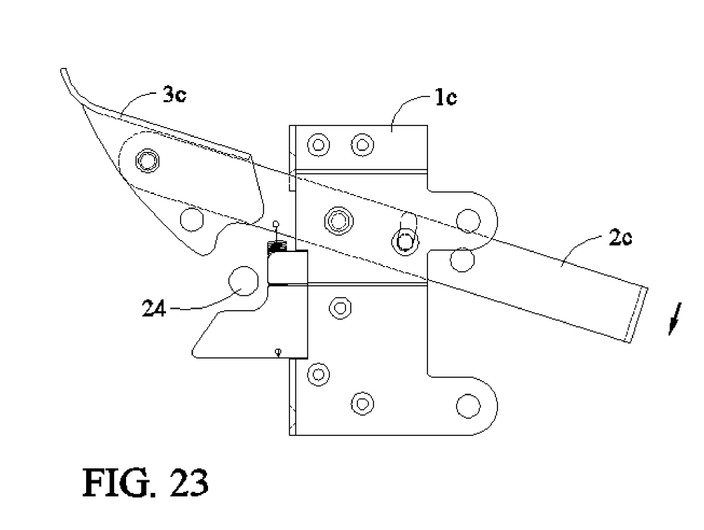

FIG. 23 shows the handle bar 2c being pushed downwardly in the arrow direction in order to lift the latch-hook bracket 3c away from the locking bolt 24. The base plate 1c is installed on a gate or fence frame structure, or can be configured to be installed on other structures. Refer to FIG. 20 for other parts not shown on FIG. 23.

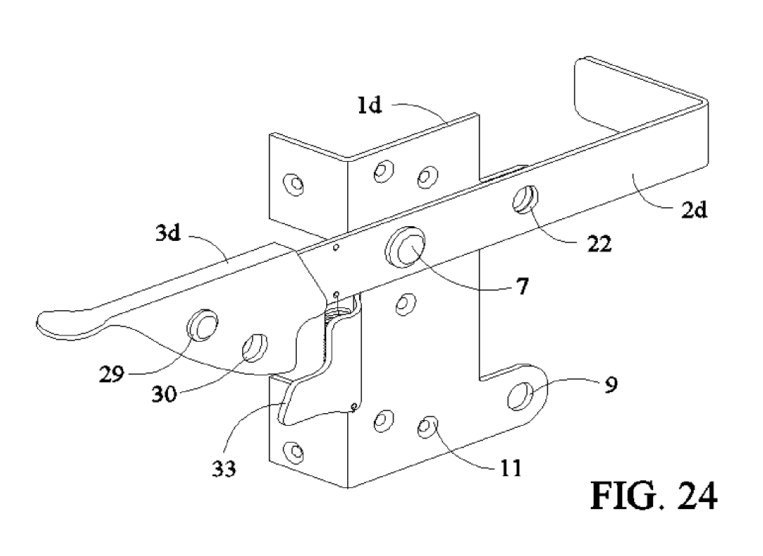

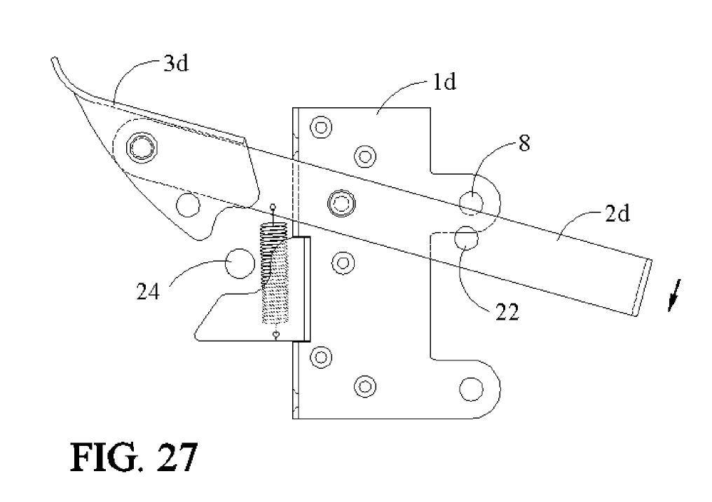

FIG. 24 shows the handle bar 2d being pivotably attached onto the exposed side of the base bracket 1d. Bolt 7 is the pivot point of the handle bar 2d in relation to the base bracket 1d. Latch-hook bracket 3d is pivotably attached to the inside end portion of the handle bar 2d at the pivot point having a bolt 29 fasten in place, and holes 30 are for a padlock (not shown) when the latch-hook bracket 3d need to be locked. A lift-stop plate 33 helps preventing the gate from being lifted out of the latched position in relation to the locking bolt (not shown). Hole 22 on the handle bar 2d is aligned with hole 8 (as seen on FIG. 27) on the base bracket 1d. Hole 9 is for a padlock (not shown) to hook into when not in used. Holes 11 are for screws or bolts fastened to install the base bracket 1d to the gate or fence frame structure.

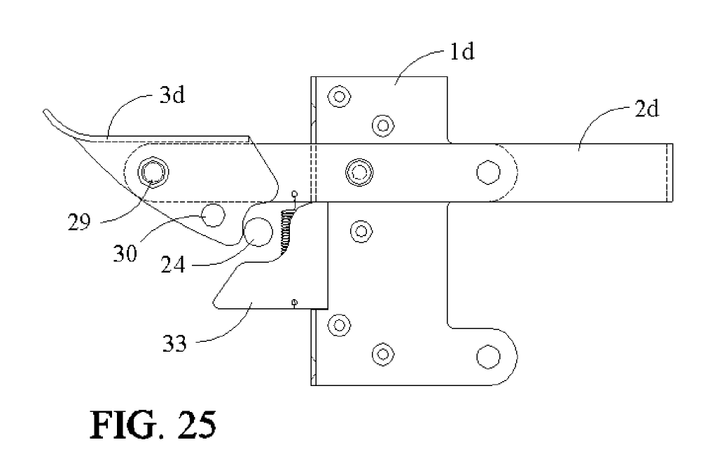

FIG. 25 shows the handle bar 2d being pivotably attached to the base bracket 1d and the latch-hook bracket 3d is pivotably attached to the inside end portion of the handle by a rivet or bolt 29. Holes 30 is for a padlock (not shown) to hook into when the latch-hook bracket 3d need to be locked. While the handle bar 2d and the latch-hook bracket 3d is in a latched position, a locking bolt 24 is being hooked in between the latch-hook bracket 3d and the lift-stop plate 33.

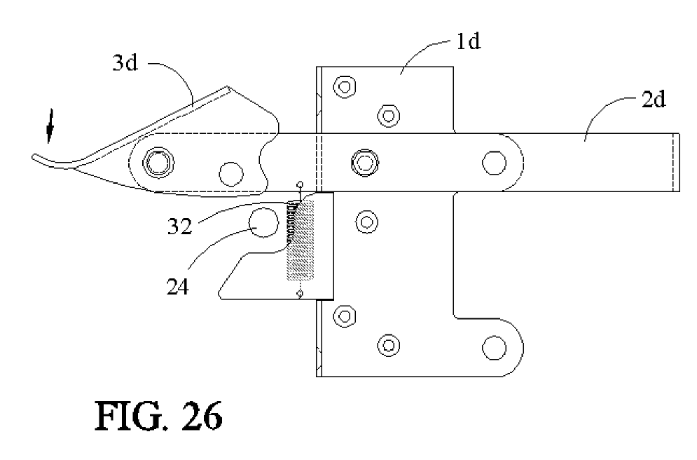

FIG. 26 shows the handle bar 2d being pivotably attached to the base bracket 1d, and the latch-hook bracket 3d is pivotably attached to the inside end portion of the handle bar 2d. The handle bar 2d is in a latched position. This demonstrates that while the handle bar 2d is being locked on the outside, a person on the inside of the fence can unlatch the gate by pressing down the latch-hook bracket 3d in the arrow direction so that the latch-hook bracket 3d can move away from the locking bolt 24. A spring 32 is being installed to help holding the handle bar 2d in rest position.

FIG. 27 shows the handle bar 2d being pivotably attached to the base bracket 1d, and the latch-hook bracket 3d is pivotably attached to the inside end portion of the handle bar 2d. By pressing the handle bar 2d downwardly in the arrow direction, the handle bar 2d is in an unlatched position; therefore that latch-hook bracket 3d on the inside are lifted upwardly away from the locking bolt 24. When the handle bar 2d is being pushed downwardly in the arrow direction to unlatch the gate, in order to keep the gate remain being unlatched, a padlock hook can be inserted into hole 22 or hole 8 to temporarily keep the gate latch from being latched.

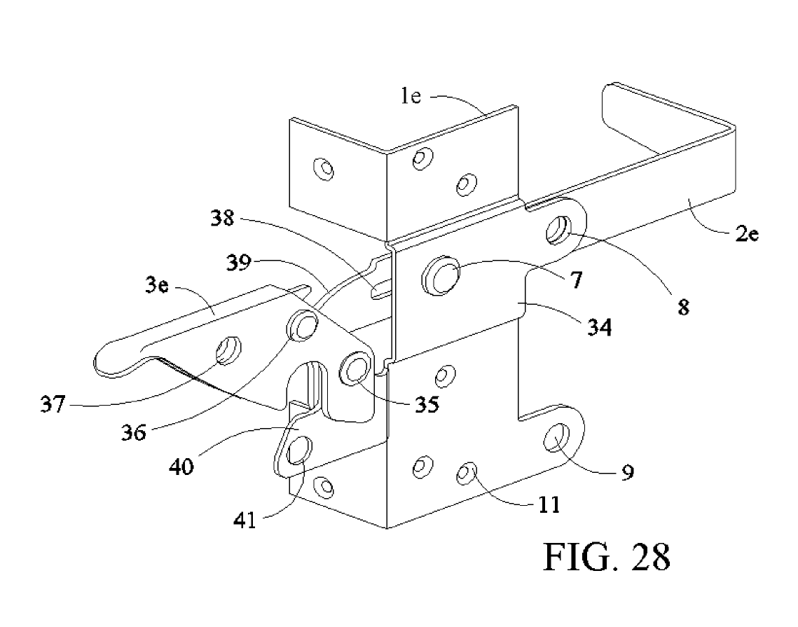

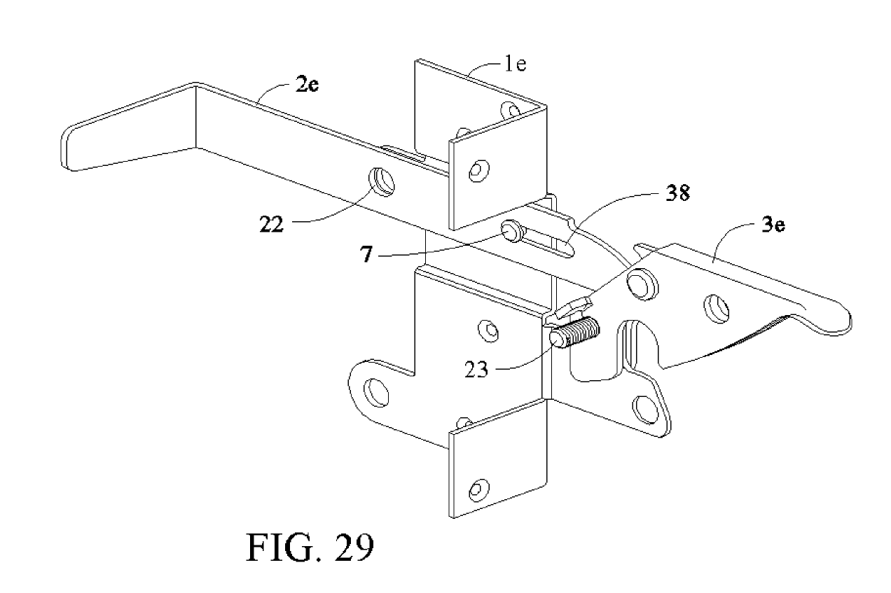

FIG. 28 depicts the third preferred embodiment of the multi-function latch. The latch-hook bracket 3e is pivotably attached by a bolt 35 to the inside extended portion of the base bracket 1e which extends further to become a lift-stop plate 40 and has a hole 41 for a padlock (not shown) to hook into when not in use. The handle bar 2e is slidably fastened to the inside surface of the projected wall portion 34 by a rivet or a bolt 7. The handle bar 2e has a horizontal sliding channel 38 so that the handle bar 2e can be pulled from outside the fence. The handle bar 2e also has a curved sliding channel 39 to hook onto the bolt 36 when the handle bar 2e is being pulled to lift the latch-hook bracket 3e upwardly to attain unlatched position. When the handle 2e is in rest position, a person inside the gate can lift the latch-hook bracket 3e upwardly; therefore, the bolt 36 would slide long the curved sliding channel 39 to unlatch from inside the gate even when the outside of the latch is locked. Holes 37 is used for a padlock (not shown) to hook into and lock to prevent the latch-hook bracket 3e from being lifted. Hole 8 aligns with hole 22 (as seen on FIG. 29) are used for a padlock to hook into and lock. Also, hole 9 is used for a padlock to hook into when not in use. Holes 11 are for screws or bolts (not shown) to fasten the latch onto the gate or fence frame structure. As seen on FIG. 3, a secondary locking bolt 16 and hinge-like bracket 15 can be incorporated onto the inside portion of the base bracket 1e where it can be manually set to keep the handle bar 2e from being actuated by a person on the outside of the fence.

FIG. 29 shows the back side of the latch with a base bracket 1e in relation to the handle bar 2e being slidably attached at rivet or bolt 7. The handle bar 2e can be pulled within the distance that the horizontal sliding channel 38 allowed. The latch-hook bracket 3e is pivotably attached to the extended wall portion 40 (as seen on FIG. 28) of the base bracket 1e. A bolt 35 (as seen on FIG. 28) becomes a spring rod 23 with spring loaded to help pulling the latch-hook bracket 3e to a rest position. In a rest position, hole 22 on the handle bar 2e is aligned with hole 8 on the base bracket 1e (as seen on FIG. 28) where a padlock (not shown) can be hooked into.

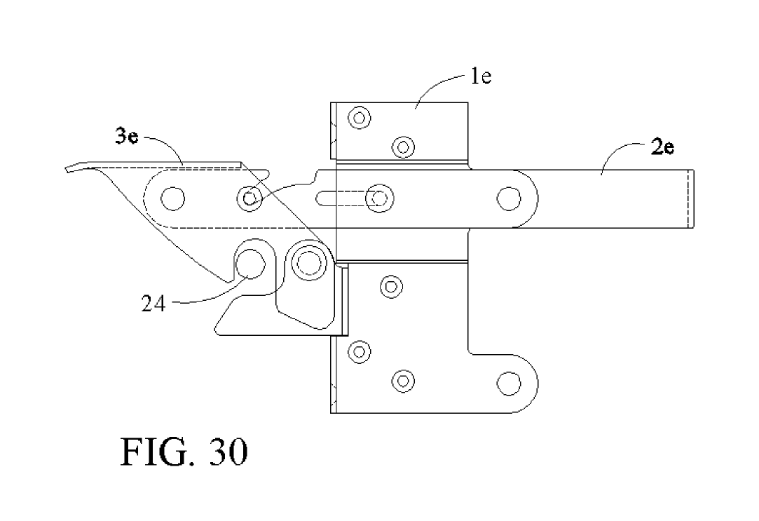

FIG. 30 shows the handle bar 2e, the latch-hook bracket 3e and the locking bolt 24 are all in a latched position in relation to the base bracket 1e.

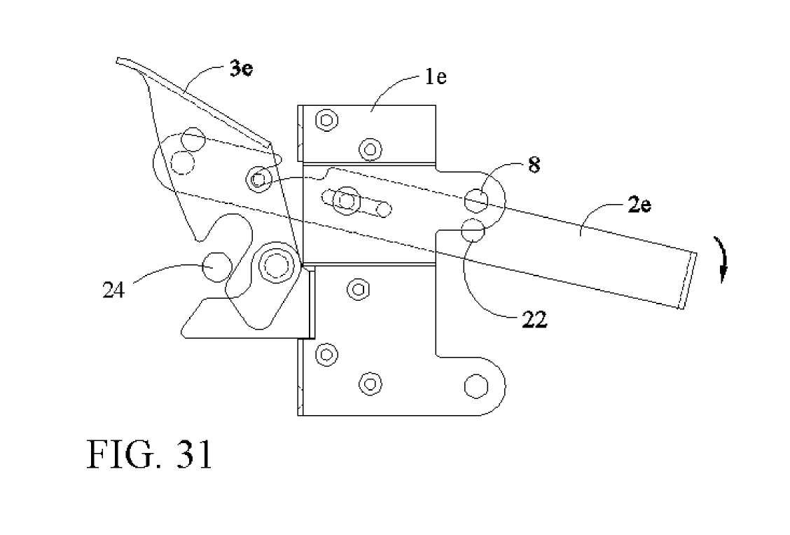

FIG. 31 shows the handle bar 2e in relation to the base bracket 1e where both handle bar 2e and latch-hook bracket 3e are in an unlatched position when the handle bar 2e is being pulled down in the arrow direction to lift the latch-hook bracket 3e away from the locking bolt 24. Hole 8 and hole 22 would be in open positions where a padlock (not shown) can be hooked into to keep the handle bar 2e and latch-hook bracket 3e in unlatched position.

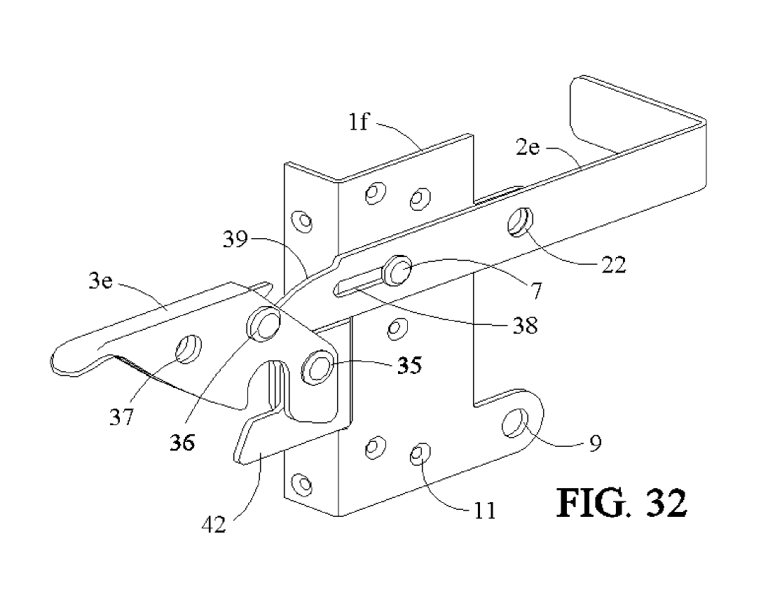

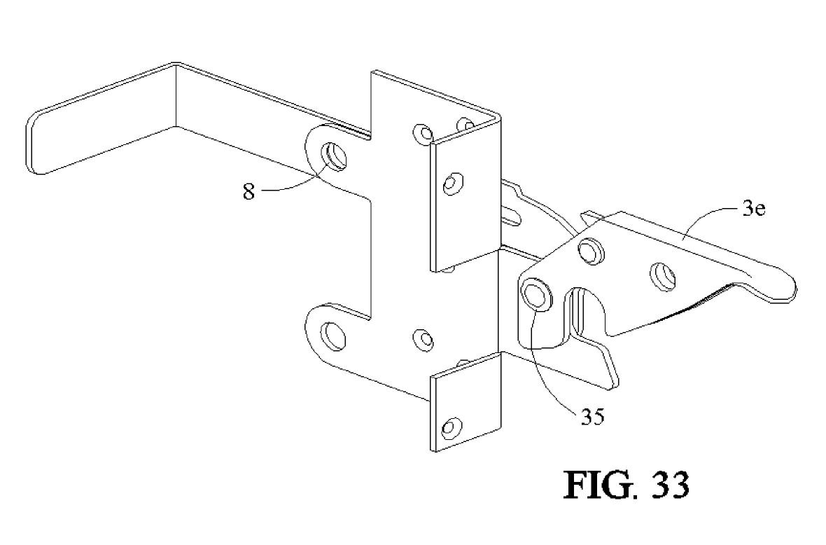

FIG. 32 shows a similar embodiment as on FIG. 28 where the handle bar 2e is positioned on the outside surface of the base bracket 1f. The base bracket 1f is modified from the base bracket 1e as seen on FIG. 28. The latch-hook bracket 3e is pivotably attached by a bolt 35 to the inside extended portion of the base bracket 1f which extends further to become a lift-stop plate 42. The handle bar 2e is being slidably fastened to the outside surface of the base bracket 1f by a rivet or a bolt 7. The handle bar 2e has a horizontal sliding channel 38 so that the handle bar 2e can be pulled from outside the fence. The handle bar 2e also has a curved sliding channel 39 to hook onto the bolt 36 when the handle bar 2e is being pulled to lift the latch-hook bracket 3e upwardly in order to attain an unlatched position. When the handle 2e is in rest position, a person inside the gate can lift the latch-hook bracket 3e upwardly; therefore, the bolt 36 would slide long the curved sliding channel 39 to unlatch from inside the gate even when the outside of the latch is locked. Holes 37 is used for a padlock (not shown) to hook into and lock to prevent the latch-hook bracket 3e from being lifted. Hole 8 (as seen on FIG. 33) aligns with hole 22 are used for a padlock. Hole 9 is also used for a padlock to hook into when not in use. Holes 11 are for screws or bolts (not shown) to fasten the latch onto the gate or fence frame structure. As seen on FIG. 3, a secondary locking bolt 16 and hinge-like bracket 15 can be incorporated onto the inside portion of the base bracket 1f where it can be manually set to keep the handle bar 2e from being actuated by a person on the outside of the fence.

FIG. 33 shows the latch-hook bracket 3e being pivotably fastened to the extended wall portion 42 (as seen on FIG. 32) by a bolt or rivet 35. When the latch is in rest position which is being latched, hole 8 would be aligned with hole 22 (as seen on FIG. 32) for a padlock (not shown) to hook into in case the latch needs to be locked on the outside of the gate.

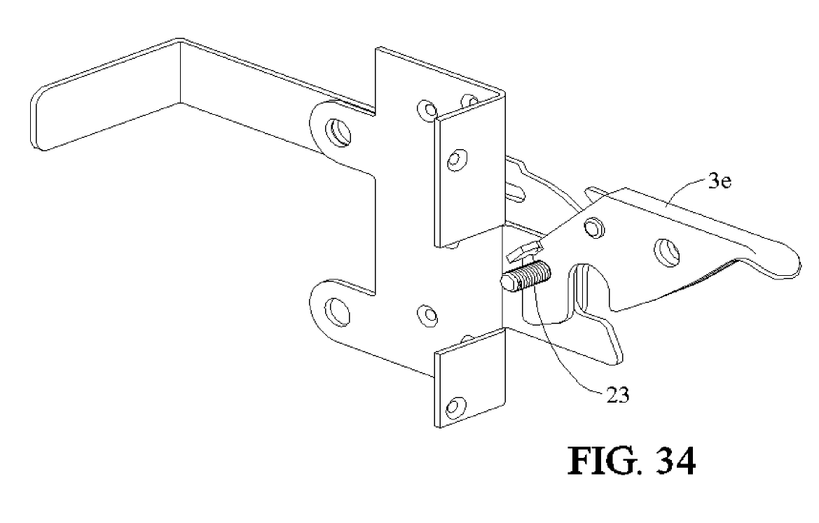

FIG. 34 shows the latch-hook bracket 3e is fastened to the extended wall portion 42 (as seen on FIG. 32) where a bolt 35 (as seen on FIG. 32) may extend to become a spring rod 23 with spring loaded to help pressing the latch-hook bracket 3e downwardly.

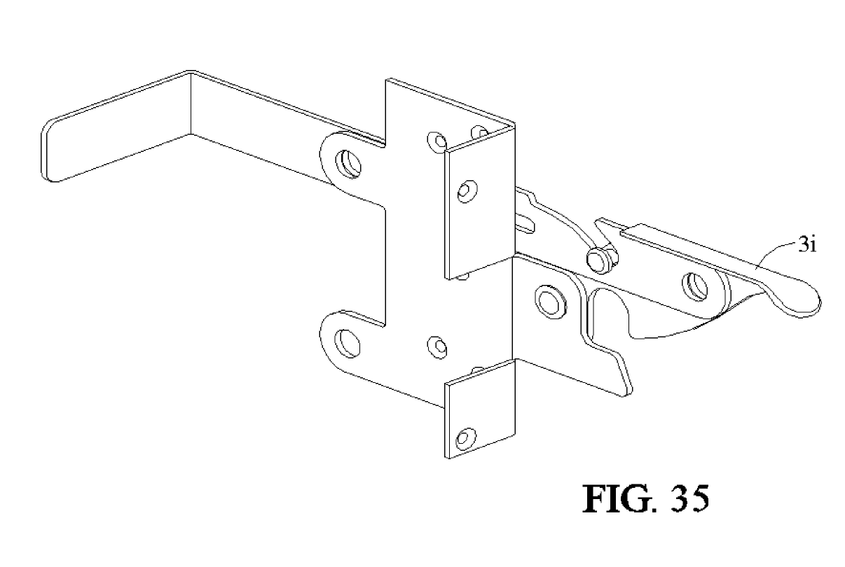

FIG. 35 shows the latch-hook bracket 3i being a single-hook structure.

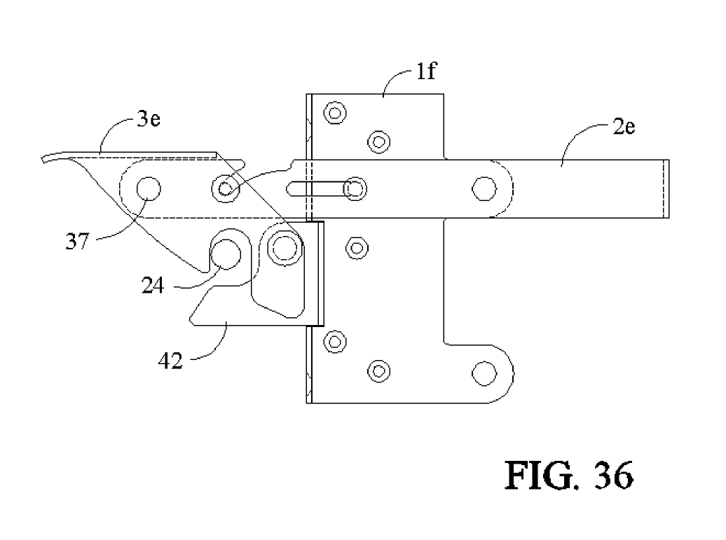

FIG. 36 shows the exposed side view of the gate latch having the handle bar 2e and latch-hook bracket 3e in a latched position in relation to the base bracket 1f. Holes 37 are for the padlock (not shown) to hook into to prevent the latch-hook bracket 3e from being lifted to unlatch the latch from the locking bolt 24. The lift-stop plate 42 helps prevent the gate from being lifted away from the locking bolt 24.

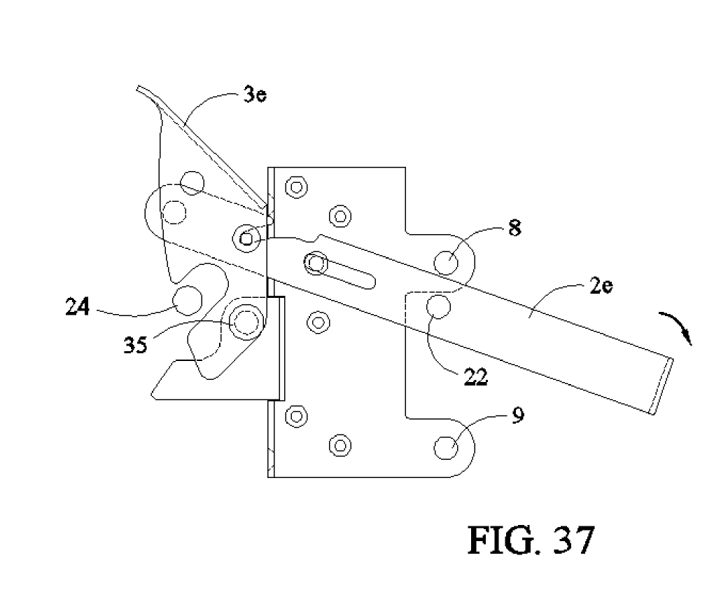

FIG. 37 shows the handle bar 2e and latch-hook bracket 3e are in an unlatched position when the handle bar 2e is being pulled horizontally while also being swung down in the arrow direction to lift the latch-hook bracket 3e away from the locking bolt 24. Hole 8 and hole 22 would be in an unaligned position where a padlock (not shown) can be hooked into either hole to keep the handle bar 2e and latch-hook bracket 3e in unlatched position. Hole 9 is an extra hole for a padlock (not shown) to hook into when not in use. Bolt 35 is used to pivotably attached the latch-hook bracket 3e to the extended portion 42 (as shown on FIG. 36) of the base bracket 1f (as shown on FIG. 36).

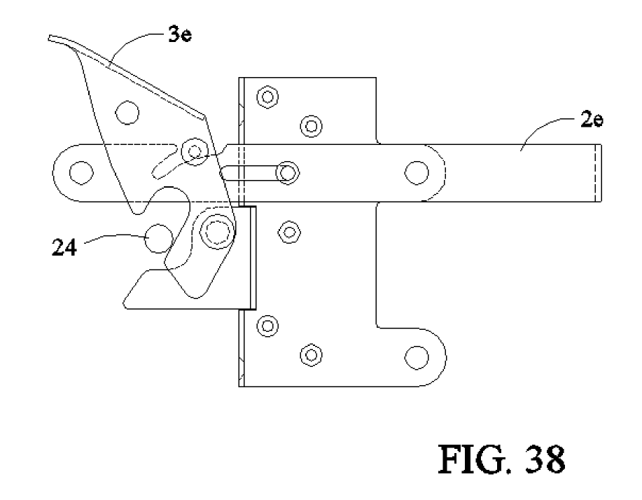

FIG. 38 shows the handle bar 2e in a rest position while the latch-hook bracket 3e is being lifted to unlatch from the locking bolt 24.

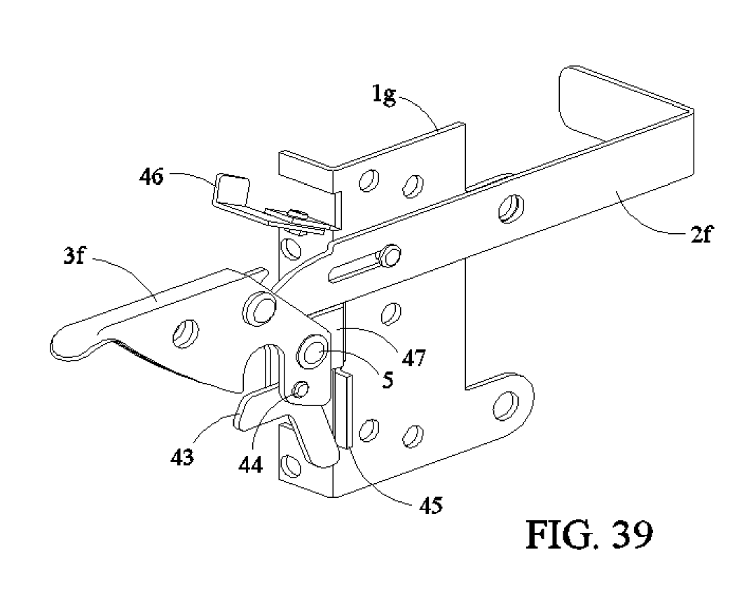

FIG. 39 shows a similar embodiment as on FIG. 32 where the base bracket 1g is modified to attain additional features including a pivotable manual lock bracket 46 as part of the base bracket 1g. It can be swung over and set on top of the handle bar 2f portion to prevent the handle bar 2f from being lifted beyond the lock bracket 46 when the lock bracket 46 is set in locked position; a new lift-stop plate 43 is pivotably attached to the bottom of the latch-hook bracket 3f by a rivet or a bolt 44. A kick plate 45 is projected from the base bracket 1g to keep the lift-stop plate 43 from swinging beyond the kick plate 45. The latch-hook bracket 3f is pivotably attached to the extended plate 47 by a rivet or bolt 5. As seen on FIG. 3, a secondary locking bolt 16 and hinge-like bracket 15 can be incorporated onto the inside portion of the base bracket 1g instead of the manual lock bracket 46 where it can be manually set to keep the handle bar 2f from being actuated by a person on the outside of the fence.

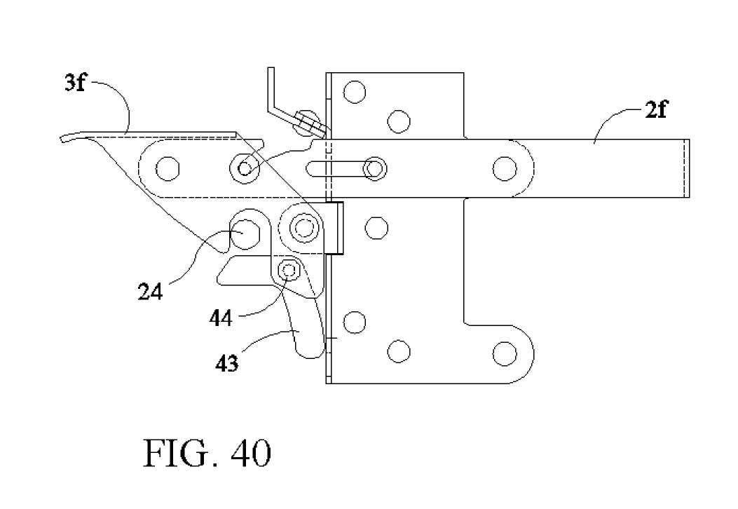

FIG. 40 shows the latch having the handle bar 2f and latch-hook bracket 3f in a latched position. When the latch-hook bracket 3f is in a latched position, the lift-stop plate 43 pivotably attached to the latch-hook bracket 3f by a rivet or bolt 44 would close in to prevent the locking bolt 24 from being swung downwardly.

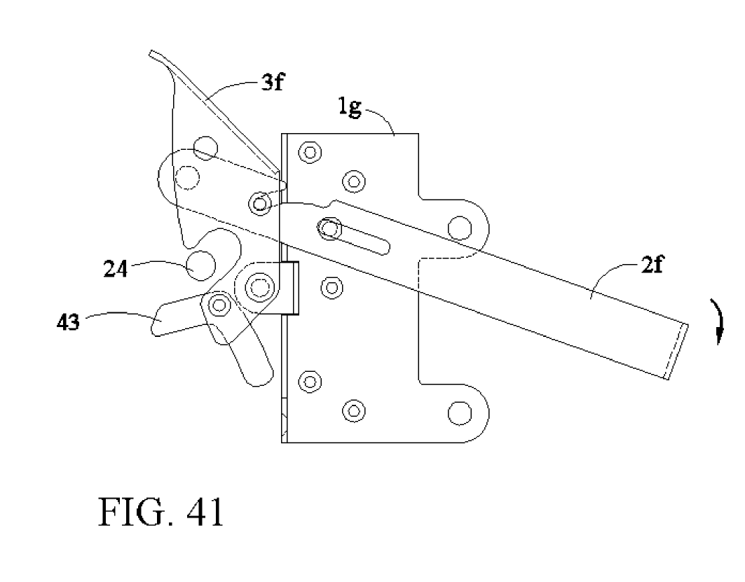

FIG. 41 shows the handle bar 2f is being pushed down in the arrow direction so that the latch-hook bracket 3f can then pivot upwardly to disengage from the locking bolt 24. Then the lift-stop plate 43 is hung neutrally with both wings being slanted. The base bracket 1g is simplified and can be modified to add features similar to other mentioned features.

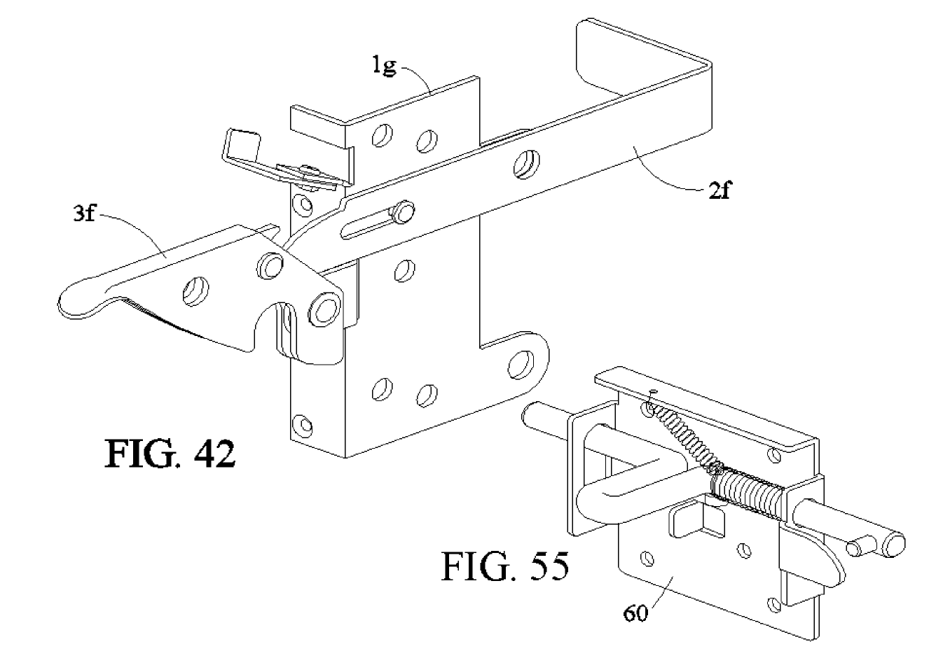

FIG. 42 shows a similar embodiment as on FIG. 39 where the base bracket 1g is modified to remove the lift-stop plate 43 (as seen on FIG. 39) from the latch-hook bracket 3f. Latch bolt 60 (as seen on FIG. 55) would be best to use with the latch-hook bracket 3f in this case. So that the locking bolt on latch bolt 60 can be pushed to swing downwardly or slide horizontally away from the latch-hook bracket 3f.

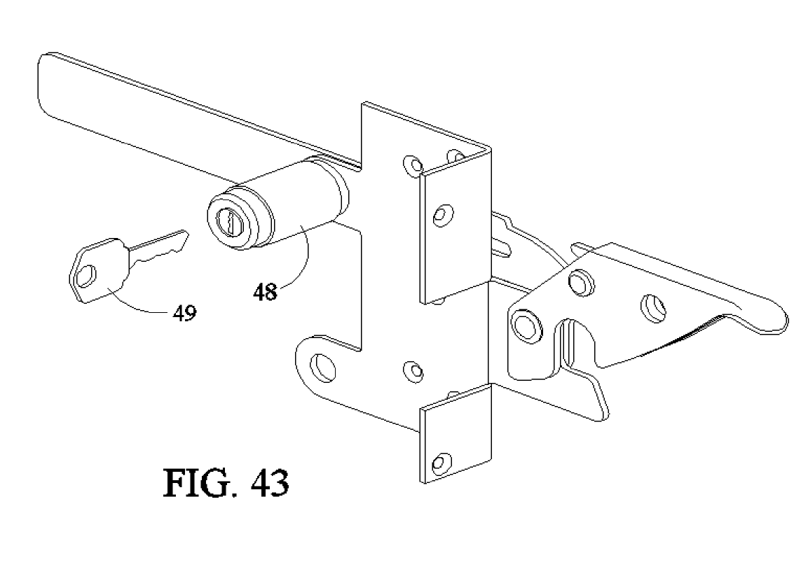

FIG. 43 show the camlock 48 and key 49 being utilized on the back side of the latch. This camlock can be incorporated to any base bracket or handle bar previously mentioned in this invention.

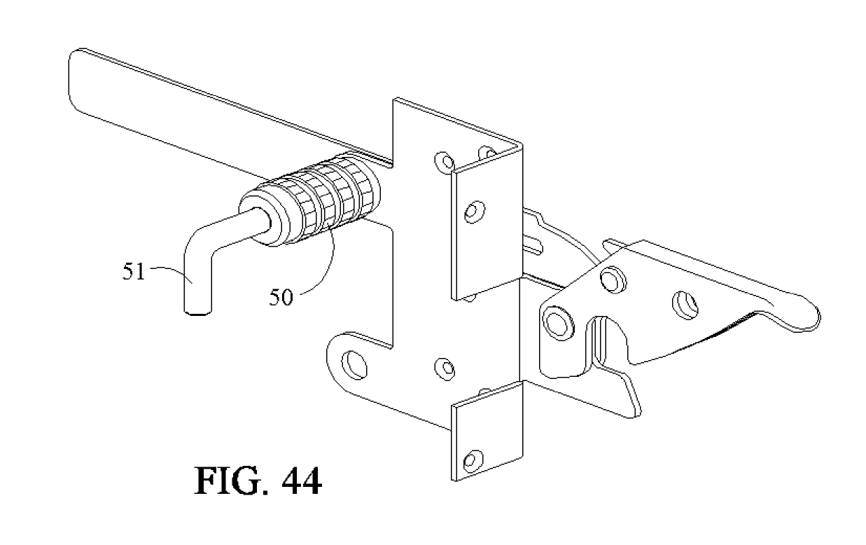

FIG. 44 shows an incorporated camlock 50 with combination code rings and locking bolt 51 being installed as part of the base place. This camlock can be utilized on any base bracket or handle bar previously mentioned in this invention.

FIG. 45 shows the handle bar 2a having hole 22 for a padlock to hook into, hole 54 for guiding bolt 18 to fasten into, hole 7b for a bolt to pivotably attached the handle 2a with a bolt fastened to guide the handle bar 2a. Handle bar 2a can also be flat without the extended bent portion. Hole 20 is aligned with hole 6 on latch-hook bracket 3a (as seen on FIG. 3) in latched position and can be used for a padlock when needed. A pull rod 14 is installed onto the end portion of the handle bar 2a to pull the latch-hook bracket 3a (as seen on FIG. 3) pivotably upward and out of the latched position.

FIG. 46 show the handle 2a (as seen on FIG. 45) having a guide hook 25 in place of the guiding bolt 18 (as seen on FIG. 45).

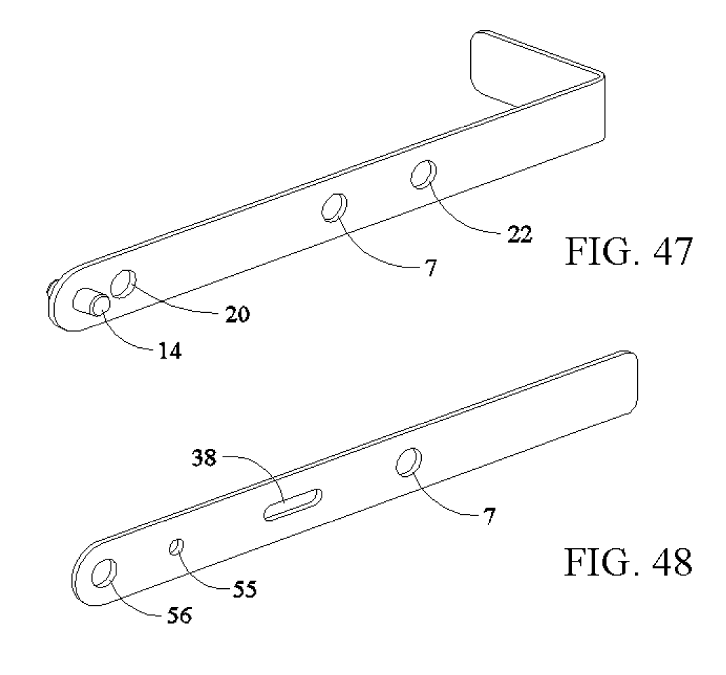

FIG. 47 shows the handle bar 2b (as seen on FIG. 12), as used on base bracket 1b, having hole 22 for a padlock to hook into, hole 7 for a bolt to pivotably attached the handle bar 2b to the base bracket 1b, hole 20 for a padlock to hook into, pull rod 14 for lifting the latch-hook bracket pivotably out of latched position.

FIG. 48 shows the handle bar having a hollow channel 38 as also seen on FIG. 32 so the user can pull the handle bar to actuate the gate latch on certain base bracket. Hole 56 is for a padlock to hook into when needed. Hole 55 is for a rivet or bolt which pull the latch-hook bracket pivotably upward when the handle bar is being pulled. Hole 7 is for a padlock to hook into to set the latch in locked position.

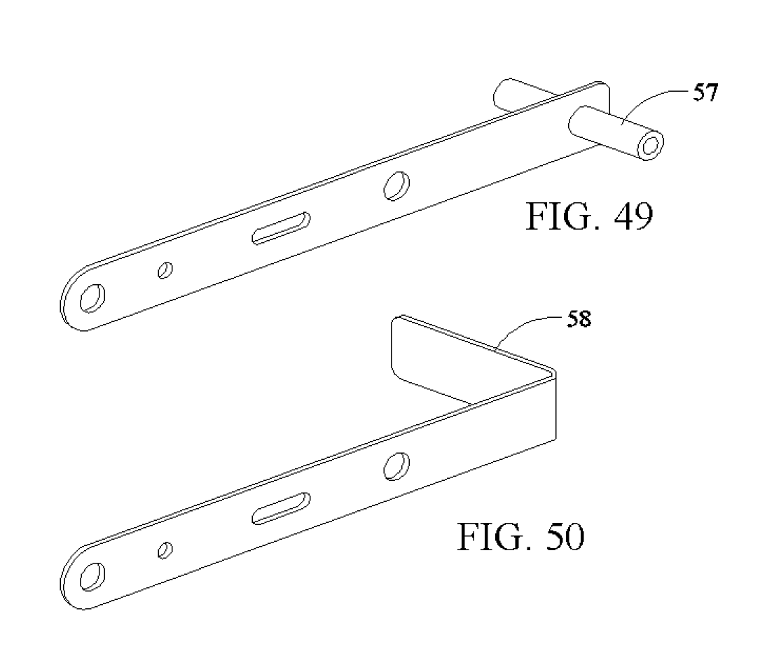

FIG. 49 shows the handle bar having a handle rod 57 installed on the outside end portion of the handle bar. This handle rod 57 can be utilized on any handle bar previously mentioned in this invention.

FIG. 50 shows a handle bar having a handle portion 58 bent 90 degrees.

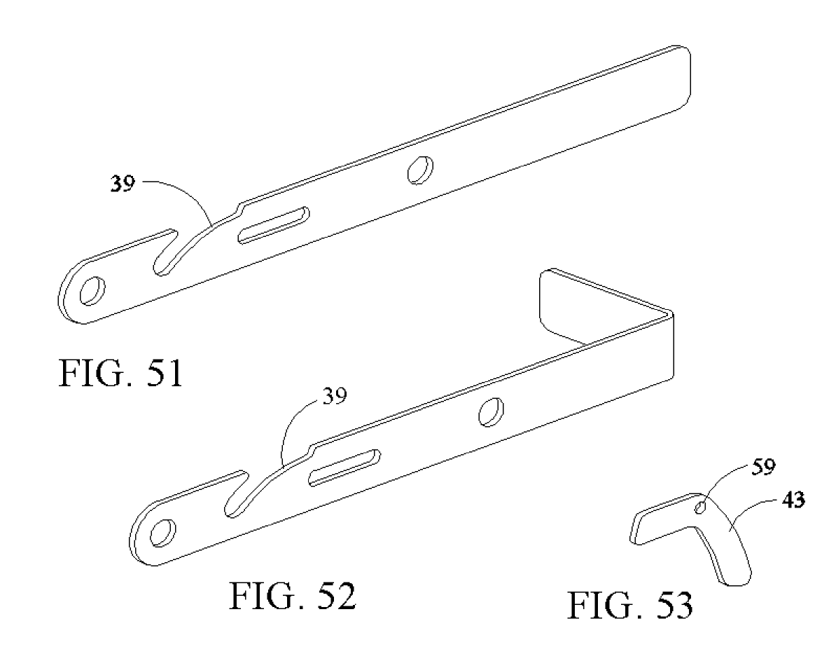

FIG. 51 shows the handle bar 2e (as seen on FIG. 28 or FIG. 32) having a curved sliding channel 39 as used on base bracket 1e (as seen on FIG. 28) or base bracket 1f (as seen on FIG. 32). This handle bar 2e is flat without a bent portion.

FIG. 52 shows the handle bar 2e (as seen on FIG. 28 or FIG. 32) having a curved sliding channel 39 as used on base bracket 1e (as seen on FIG. 28) or base bracket 1f (as seen on FIG. 32). This handle bar 2e has a bent portion on the outside end of the handle.

FIG. 53 shows the lift-stop plate 43 having hole 59 for use on latch-hook bracket 3f (as seen on FIG. 39);

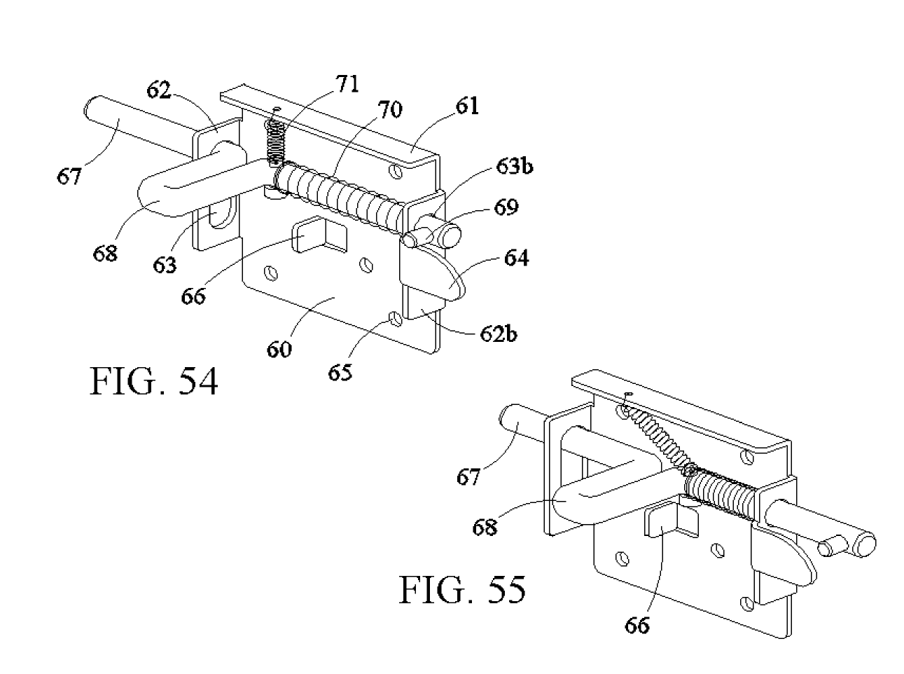

FIG. 54 shows a latch bolt mechanism having a base wall panel 60 with screw holes 65; first extended wall panel 62 having an oblong hole 63 for the locking bolt 67 sliding vertically to achieve latching or unlatching action; second extended wall panel 62b having a hole 63b for the end portion of the locking bolt 67; additional extended wall panel 61 having a hole for a spring 71 to hook into said locking bolt 67 having a bent portion which form a thumb/finger handle 68; other extended wall panel can be incorporated for attachment of other parts; said locking bolt 67 having a spring 70 helping to push the locking bolt 67 to fully extended position; said locking bolt has a stop bolt 69 when engage with extended wall panel 64 which help prevent the locking bolt 67 from being turned when being slide at fully extended position; wall panel 66 is positioned so that the thumb/finger handle 68 can be set onto to keep the locking bolt in retracted position; another wall panel can be incorporated to include a hole for a padlock to lock the locking bolt 67 in fully extended position. In this configuration, the locking bolt 67 and springs 70 & 71 are visible.

FIG. 55 shows the latch bolt mechanism having the locking bolt 67 being retracted with the thumb/finger handle 68 aligning with wall panel 66 where the thumb/finger handle 68 can be set onto to keep the locking bolt 67 in unlatched position.

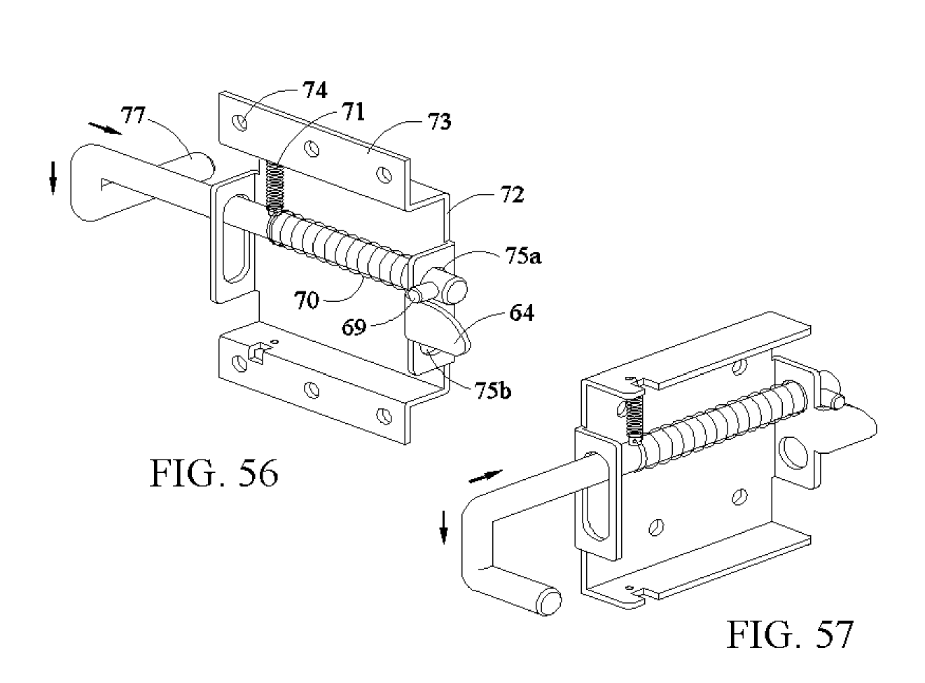

FIG. 56 shows another latch bolt mechanism having a base plate 72 with extended wall panels 73 where the screw holes 74 are positioned; hole 75a or hole 75b are for the end portion of the locking bolt 77 to be inserted and locked in by a stop bolt 69. This latch bolt housing is fabricated to be reversible for left-hand/right-hand placement. Other features are similar to latch bolt mechanism as shown on FIG. 54. In this configuration, the latch bolt mechanism hides most of the locking bolt 67 including the springs 70 & 71.

FIG. 57 shows another latch bolt mechanism having minor modifications.

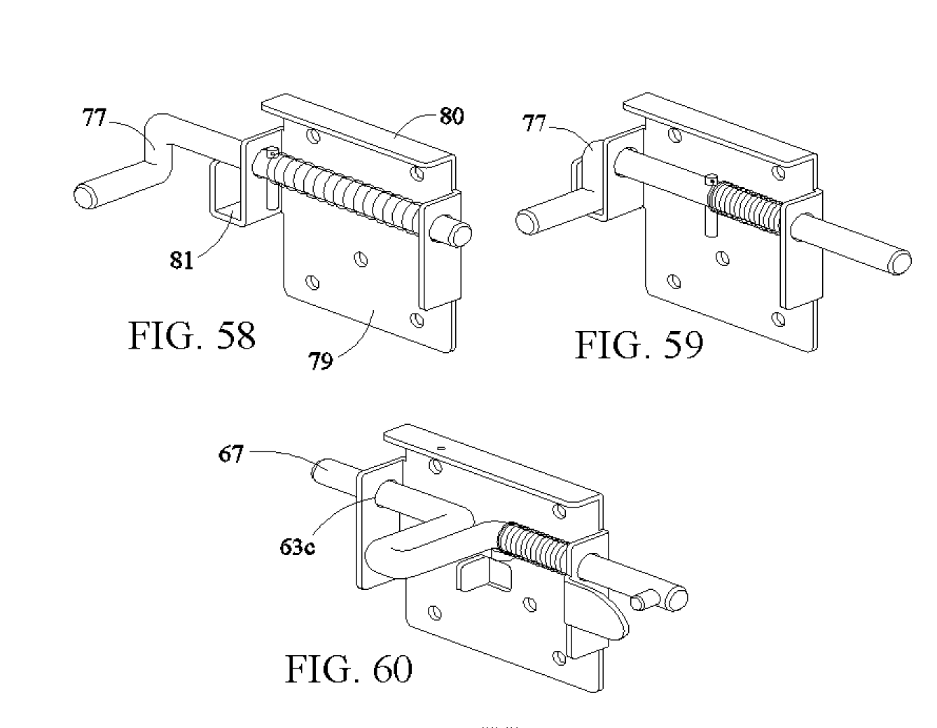

FIG. 58 shows another latch bolt embodiment being installed with the locking bolt 77 and springs visible. The extended wall panel 81 is bent to form a pocket for the front end of the locking bolt 77 to set into. The base wall panel 79 is for fastening onto a fence frame structure or gate. The extended wall panel 80 can be extended horizontally and vertically downward to cover the spring. This latching bolt mechanism being installed with the latch bolt 77 and springs visible.

FIG. 59 shows the latch bolt 77 in a retracted position.

FIG. 60 shows a latch bolt mechanism similar to one shown on FIG. 54; however, hole 63c is for the latch bolt 67 to slide horizontally to pair up with the latch-hook brackets with a lift-stop plate 13, 26, 28, 33, 40, 42 or 43 as seen on FIG. 3, 12, 20, 24, 28, 32 or 39.

The intended application for the multi-function latch and latch bolt is for installation on a gate, storage barn door, or the like, to prevent intruders or unauthorized persons from entering into an enclosed area. Providing access to certain person does not mean that one must have the gate unlocked. Leaving the gate unlocked may mean an easy access for unauthorized persons. Providing the degree of security necessary, ease of use, reliability, low cost, convenience, and providing easy access to authorized persons by having a gate latch installed with novel multi-function latch and latch bolt installed.

Although the present invention herein has been described with reference to particular embodiments, it is to be understood that these embodiments are merely illustrative of the principles and methods of the present invention. It is therefore to be understood that numerous modifications may be made to the illustrative embodiments and that other arrangements may be devised without departing from the spirit and scope of the present invention as defined by the appended claims.

What is claimed is:

1. A gate latch and latch bolt comprising:
a latch-hook bracket being pivotably attached or rotatably hooked to an inside portion of a handle bar and/or pivotably attached to the base bracket; said latch-hook bracket is self-latched when a gate is closed; said latch-hook bracket having at least one through hole for a padlock to hook onto, and at least one through hole for attachment to an inside portion of the handle bar and/or base bracket, and at least for one spring; said latch-hook bracket having a double-hook structure or single-hook structure; said double-hook structure including a first plate on top, a second plate on the left side and a third plate on the right side; said first plate having an extended portion having a spoon-like plate for lifting the double-hook structure pivotably upward or pushing pivotably downward; said second plate and third plate are connected perpendicularly to first plate and extended vertically in the downward direction from first plate; said second plate and third plate having substantially identical profile with surfaces that are parallel with each other; said second plate and third plate having a space in between so that the inside end portion of the handle bar can be inserted, pivotably attached and/or hooked and partially rotatable in between second plate and third plate; said double-hook structure having first through holes, second through holes and may have additional through holes; said double-hook structure having side-by-side hollowed-out portions forming a catch tongue of hook-shaped profile on the second plate and third plate for the locking bolt to be engaged in when latched; said catch tongue of hook-shaped profile is configured near the bottom of the second plate and third plate; another catch tongue or dual-catch tongues may be utilized for at least one side of the pull rod on the inside portion of the handle bar; said pull rod may be replaced with a rivet or bolt fastened in place; said double-hook structure may include a rod extended from the pivot point of the latch-hook bracket and handle bar or from the pivot point of the latch-hook bracket and the inside extended portion of the base bracket; said latch-hook bracket may have a spring rod or an extended portion of the bolt installed to pivotably hold the latch-hook bracket to the handle bar or to the base bracket; said spring rod or extended portion of the bolt projecting on one side so that a torsion spring can be installed onto and hooked onto the handle bar or base bracket in order to keep the latch-hook bracket to swing downwardly and rest onto the inside end of the handle bar; said latch-hook bracket may include a lift-stop plate swinging open when the latch-hook bracket is lifted; said double-hook structure is configured to partially swing upward and disengage from the latch bolt in order to unlatch and open the gate from inside the fence even when the gate latch is locked on the outside with an incorporated lock or a padlock;
a handle bar being elongated with an inside end portion pivotably attached to the latch-hook bracket and an outside end portion becoming an actuating handle portion on the outside of the fence; said handle bar is pivotably and/or slidably attached to the base bracket at the aligned pivot hole or channel on the handle bar and the threaded bolt hole on the base bracket; said handle bar having at least one through hole for the padlock to hook onto; said handle bar may be flat, having a bent portion on the outside which is perpendicular to the handle or have a rod-like cylinder installed at the outside end portion of the flat handle bar;
a base bracket having at least one main plate, at least one extended plate and multiple through holes; said multiple through holes are for the screws or bolts/nuts to be fastened through and into the gate or fence structure, at least one threaded bolt hole for a bolt to pivotably hold the handle bar to the base bracket, and other through holes for attachments including—but not limited to—at least one spring and at least two through holes for padlocks; said base bracket is fixedly installed to an edge of a gate swinging about a vertical axis or fixedly installed to a fence frame/post; said main plate may be formed with a center portion projecting outwardly so that the handle bar can be pivotably installed onto the inside of the projected portion; said top portion and bottom portion of the main plate are on the same plane; said main plate having a handle bar pivotably attached thereto; said base bracket may include at least one bent plate which is perpendicular and/or parallel to the main plate; said base bracket may be flat and have at least one bent plate extended perpendicularly from the base plate; said base bracket may have a lift-stop plate on the inside portion of the base bracket to prevent the gate from being lifted away from the latch bolt; said lift-stop plate may have a hole for a spring to hook into; said base bracket having at least one extended portion with a through hole which is aligned with a through hole on the handle bar to receive a padlock; said base bracket may have a camlock incorporated with key or with combination codes;
a latch bolt having a base housing, a locking bolt and at least one spring; said base housing having at least one main panel, at least two extended panels projecting perpendicularly from the main panel and at least one secondary extended panel projecting perpendicularly from an extended panel; said first extended panel in the front portion of the locking bolt having a round through hole or an oblong through hole; said second extended panel in the rear portion of the locking bolt having a round through hole; said base housing may have a holding panel extended from the main panel and projected perpendicularly from the main panel; said holding panel is for the locking bolt handle to be held in a recess position to prevent catching onto the latch-hook bracket; said base housing may have top and/or bottom extended panel; said base housing may have a cover panel which is parallel to the main panel to cover the locking bolt and spring; said secondary extended panel may be used to prevent the locking bolt from turning when in the fully extended position; said locking bolt can slide horizontally away from the latch-hook bracket and/or pivotably swing downward away from the latch-hook bracket; said locking bolt having a bent portion to become a locking-bolt handle or a handle bolt installed onto the locking bolt for a person to hold with fingers/thumb to slide or push/pull to actuate the locking bolt; said at least one spring is an expansion spring and/or compression spring utilized to push the locking bolt horizontally toward the latch-hook bracket and hold the locking bolt upwardly.

2. Latch-hook bracket according to claim 1, wherein in one embodiment, the double-hook structure having first through holes aligned horizontally through the second and third plate of the double-hook structure, sharing first axis and positioned near the spoon-like plate; said first though holes on the double hook structure are positioned to aligned with the first through hole near the inside end portion of the handle bar; said first through holes on the double-hook structure and near the inside end portion of the handle bar are intended for a padlock to hook into when the latch-hook bracket is in latch position; said double-hook structure having second through holes aligned horizontally through second and third plate, sharing second axis and positioned near the lower back portion of the double-hook structure where the double-hook structure is pivotably attached to inside portion of the handle bar; said second through holes having a rivet, bolt/nut or an extended bolt/nut to pivotably attached the double-hook structure to the handle bar; said double-hook structure having a dual catch pockets to hold the pull rod near the inside end of the handle bar; said double-hook structure having side-by-side hollowed-out portions at the bottom portion of the double-hook bracket forming a catch tongue of hook-shaped profile on the second plate and third plate for the locking bolt to be engaged in when latched; said double-hook structure can be replaced with a single-hook structure.

3. Latch-hook bracket according to claim 2, wherein, when being unlocked both inside and outside, a person standing on the inside of the gate may unlatch the latch-hook bracket or slide the locking bolt away to unlatch and push the gate outwardly for outswing gate or pull to open the gate inwardly for inswing gate; on the other hand, a person standing on the outside of the gate may pull the handle downwardly to unlatch the gate and be able to open the gate outwardly for outswing gate or push the gate to open for inswing gate.

4. Handle bar according to claim 1, wherein, a first bolt is pivotably attached the handle bar to the base bracket and a second bolt is attached through the cut-away channel on the base bracket and fastened to the handle bar so that the handle bar can be sliding within the cut-away channel when the handle bar is actuated; said second bolt can be replaced by an incorporated hook extended from the handle bar and hooked onto a side of the cut-away channel on the base bracket; said handle bar having a hole aligning with a hole on the outside portion of the base bracket so that a padlock can be hook into; said handle bar having a spring hole located under the pivot bolt where a spring is hooked to another spring hole located on the extended portion of the base bracket.

5. Base bracket according to claim 4, wherein, a secondary locking bolt is incorporated onto the inside portion of the base bracket positioned above the handle bar where it can be manually set to keep the handle bar from being actuated on the outside of the gate.

6. Latch-hook bracket according to claim 1, wherein, in another embodiment, the double-hook structure having first through holes aligned with a first through hole near the inside end portion of the handle bar where the double-hook structure is pivotably attached to the handle bar; said double-hook structure having second through holes positioned under the inside portion of the handle bar where a padlock can be hooked into; said handle bar having a spring hole for a spring to hook into at one end and the other end of the spring is hooked into a spring hole located at the bottom of a lift-stop plate extended from the base bracket; said double-hook structure is positioned so that a person on the inside the fence can push the double-hook bracket downwardly to unlatch from the locking bolt; said double-hook structure may be replaced with a single-hook structure.

7. Latch-hook bracket according to claim 1, wherein, in another embodiment, the double-hook structure having first through holes aligned with a through hole near the inside end portion of the handle bar where a padlock can be hooked into; said double-hook structure having second through holes aligned horizontally through the second and third plate of the double-hook structure, sharing second axis and positioned near the upper-middle corner of the double-hook structure; said second through holes on the double-hook structure are positioned to align with the second through hole or the hollow sliding channel on the inside portion of the handle bar; said second through holes on the double-hook structure having a rivet or a bolt fastened through the second through holes or the hollow sliding channel on the handle bar which is aligned and positioned in between the second plate and third plate of the double-hook structure; said double-hook structure having third through holes aligned horizontally through the second and third plate of the double-hook structure, sharing third axis and positioned near the upper back corner of the double-hook structure; said third through holes on the double-hook structure are positioned to align with the third through hole on the extended portion of the base bracket; said extended portion of the base bracket may have a through hole for a padlock to hang onto; said double-hook structure may be replaced with a single-hook structure.

8. Latch-hook bracket according to claim 7, wherein, when being unlocked on both inside and outside, a person standing on the inside of the gate may lift the latch-hook bracket or slide the locking bolt away to unlatch and push the gate to open outwardly for outswing gate or pull to open the gate inwardly for inswing gate; on the other hand, a person standing on the outside of the gate may pull the handle horizontally to unlatch the gate and be able to pull the gate outwardly for outswing gate or push to open for inswing gate.

9. Latch-hook bracket according to claim 7, wherein, the double-hook structure may have fourth through holes near the bottom; said double-hook structure having a lift-stop plate pivotably attached in between the second and third plate at the fourth through holes; said lift-stop plate may be pivotably attached to the single-hook structure.

10. Latch-hook bracket according to claim 1, wherein, the fourth through holes are aligned horizontally through the second and third plate of the double-hook structure, sharing forth axis and positioned near the bottom of the double-hook structure; at least one of the fourth through holes is used for a spring to hook onto.

11. Latch hook bracket according to claim 1, wherein, in another embodiment, can be simplified to be a single-hook structure which can be used in place of the double-hook structure and pivotably attached to the inside end portion of the handle bar; said single-hook structure having one vertical plate which is positioned on a side of the handle bar similar to the second plate or third plate on the double-hook structure; said single-hook structure may have a first plate similar to the first plate on the double-hook structure connected; said first plate may include a spoon-like plate as part of the first plate; said spoon-like plate can be incorporated horizontally and extended from the single-hook plate without the first plate being utilized; single-hook structure may have through holes similar to the through holes on the second or third plate of the double-hook structure; said single-hook structure is configured to partially swing upward and disengage from the latch bolt in order to unlatch and open the gate from inside the fence even when the gate latch is locked on the outside with an incorporated lock or a padlock.

12. Gate latch according to claim 1, wherein, in other embodiments, may be configured to be reversible so that the gate latch can be installed for left-hand or right-hand operation, or installed on gate edge or fence edge structure; said gate latch may also be modified for installation on other structures.

13. Single-hook structure according to claims 2, 6 & 7, wherein, having rivets and/or bolts fastened at pivot holes; said pivot holes may be threaded; said bolts may include self-locking nuts fastened.

14. Actuating handle portion according to claim 1, wherein, in other embodiments, having a bent portion about 90 degrees which is parallel to the gate surface or having a rod-like handle extending perpendicularly and horizontally on one side or both side of the handle bar which is parallel to the gate surface.

15. Base bracket according to claim 1, wherein, may include an incorporated lock on the outside of the base bracket; said incorporated lock being configured to keep the handle bar from being actuated; said incorporated lock can be unlocked by a key or combination codes; said base bracket having through holes, cut-outs and bent plate portions adapted for a variation of configurations, handle bar placements, latch-hook bracket support and/or configurations of the latch depending on the method of operation of the latch and latch bolt.

16. Gate latch according to claim 1, wherein, the latch-hook bracket is pivotably attached or being hooked onto the inside portion of the handle bar and/or the extended portion of the base bracket, and the handle bar is pivotably attached and/or slidably attached to the base bracket; said latch-hook bracket can be swung pivotably upward from rest position so that a person standing on the inside of the gate can unlatch and open the gate even when the outside of the gate latch is locked; said method for unlatching the gate latch from inside the gate even when the outside of the gate latch is locked comprising: lifting the latch hook bracket pivotably upward, or pushing the latch hook bracket pivotably downward, to unlatch from the latch bolt installed on the adjacent structure; pushing the gate to open the gate outwardly if the gate latch is installed on the gate and the latching bolt is installed on the fence frame structure for outswing gate, or pulling the gate to open the gate inwardly if the gate latch is installed on the fence frame structure and the latching bolt is installed on the inswing gate; sliding the locking bolt on the latching bolt mechanism horizontally away from the latch-hook bracket or pushing the locking bolt pivotably downward to disengage the locking bolt from the latch-hook bracket to open the gate outwardly or inwardly;

17. Latch bolt according to claim 1, wherein, the latch bolt mechanism having a base housing and locking bolt; said base housing having base wall panel with screw holes and at least 2 extended wall panels including first wall panel, second wall panel, and may include additional wall panels; said first extended wall panel having an oblong hole for the locking bolt sliding vertically and/or horizontally to achieve latching or unlatching action; said second extended wall panels having at least one hole for the end portion of the locking bolt to be inserted and slide; other extended wall panels may include holes for a spring to hook into; said locking bolt having a bent portion which may form a thumb/finger handle in the mid-section or at the front end of the locking bolt; said locking bolt having at least one spring helping to align and/or push the locking bolt to fully extended position; said locking bolt has a stop bolt installed at the back end of the locking bolt; said stop bolt helps to prevent the locking bolt from being turned when being in fully extended position; a projected wall panel can be utilized to hold or lock the thumb/finger handle in a retracted position; another wall panel can be incorporated to include a hole for a padlock to lock the locking bolt in fully extended position.

18. Latch and latch bolt according to claim 1, wherein, the latch and latch bolt can be configured for left-hand or right-hand installation; said latch bold can be modified for installation on inswing or out swing gate in all of which to achieve an objective that a person standing on the inside of the gate can disengage the latch-hook bracket from the latch bolt, or disengage the latch bolt from the latch-hook bracket in any of which method to unlatch and open the gate from inside the fence even when the latch is locked on the outside
